(19) United States
(12) Patent Application Publication
(10) Pub. No.: US 2025/0093680 A1
(43) Pub. Date: Mar. 20, 2025

(54) AIR FLOATING VIDEO DISPLAY SYSTEM, LIGHT SOURCE USED THEREFOR, RETROREFLECTOR, AND OPTICAL SYSTEM

(71) Applicant: Maxell, Ltd., Kyoto (JP)

(72) Inventors: Koji HIRATA, Kyoto (JP); Koji FUJITA, Kyoto (JP); Toshinori SUGIYAMA, Kyoto (JP); Yuriko INADACHI, Kyoto (JP); Tetsuki NISHIMURA, Kyoto (JP)

(21) Appl. No.: 18/728,219

(22) PCT Filed: Dec. 22, 2022
(86) PCT No.: PCT/JP2022/047325

§ 371 Date: Jul. 11, 2024

(30) Foreign Application Priority Data
Jan. 12, 2022 (JP) 2022-002954
Feb. 2, 2022 (JP) 2022-015084
Feb. 8, 2022 (JP) 2022-018141
Feb. 14, 2022 (JP) 2022-020465

(51) Int. Cl. G02B 30/56; G02B 5/12

(52) U.S. Cl. CPC G02B 30/56; G02B 5/12

(57) ABSTRACT

A video is preferably displayed on outside of a space. The present invention contributes to “the third goal: Good Health and Well-being (for all people)”, “the ninth goal: Industry, Innovation and Infrastructure” and “the eleventh goal: Sustainable Cities and Communities” of the sustainable development goals. An air floating video display system includes: a display panel configured to display a video; a light source apparatus for the display panel; a retroreflector configured to reflect video light emitted from the display panel and to cause the reflected light to aerially display an air floating video of a real image; and a video light control sheet configured to convert an optical path of the video light. The video light control sheet is arranged between the retroreflector and the display panel to adjust an emission direction and a divergence angle of a video light flux emitted from the display panel.

### TECHNICAL FIELD

The present invention relates to an air floating video information display system and a light source apparatus used therefor.

### BACKGROUND ART

A video display apparatus configured to display videos in space in an air floating information display system is also disclosed in, for example, Patent Document 1.

### RELATED ART DOCUMENT

### Patent Document

Patent Document 1: Japanese Patent Application Laid-open Publication No. 2019-128722

### SUMMARY OF THE INVENTION

### Problems to be Solved by the Invention

A video display apparatus configured to directly display a video toward the outside and a method for displaying it an air (space) screen have been already known as an air floating information display system. However, in the related-art air floating video information display system, a means for preventing failures from occurring when external light enters a retroreflector configured to form an air floating video and a technique of optimally designing a light source of a video display apparatus serving as a video source of the air floating video have not been considered.

An objective of the present invention is to provide a technique capable of displaying air floating video with high visual recognition (visual (apparent) resolution or contrast) and with less influence of external light and capable of suitably displaying the air floating video in an air floating information display system or air floating video display apparatus.

### Means for Solving the Problems

In order to solve the problems, for example, configurations described in a section <CLAIMS> are employed. The present application includes a plurality of means for solving the above problems, and an air floating video display system will be exemplified below as one of the means. An air floating video display system according to one aspect of the present application includes: a display panel configured to display a video; a light source apparatus for the display panel; a retroreflector configured to reflect video light emitted from the display panel and to cause the reflected light to aerially display an air floating video of a real image, and a video light control sheet configured to convert an optical path of the video light, and the video light control sheet is arranged between the retroreflector and the display panel and adjusts an emission direction and a divergence angle of a video light flux emitted from the display panel.

### Effects of the Invention

According to the present invention, even under entering of external light, image quality of the air floating video does not decrease, and the air floating video information can be suitably displayed. Other problems, configurations, and effects than those of the above description will become more apparent from the following description of embodiments.

### BRIEF DESCRIPTIONS OF THE DRAWINGS

FIG. 1 is a diagram illustrating a configuration of a retroreflector and a formation position of an air floating image according to one embodiment of the present invention.

FIG. 2 is an explanatory diagram for explaining a formation mechanism of ghost images due to abnormal light ray caused by retroreflection according to one embodiment of the present invention.

FIG. 3 is an explanatory diagram for explaining a formation mechanism of an abnormal light ray in a retroreflector used in another air floating video information system.

FIG. 4 is an explanatory diagram for explaining a mechanism of eliminating the abnormal light ray occurring when external light enters the retroreflector according to one embodiment.

FIG. 5 is a characteristic diagram illustrating an optimum condition for using a retroreflector in the air floating video information display system according to one embodiment of the present invention.

FIG. 6 is a diagram illustrating an embodiment of a configuration of main components and a configuration of a retroreflection portion in the air floating video information display system according to one embodiment of the present invention.

FIG. 7 is a diagram illustrating a second embodiment of the configuration of main components and the configuration of the retroreflection portion in the air floating video information display system according to one embodiment of the present invention.

FIG. 8 is a diagram illustrating a third embodiment of the configuration of main components and the configuration of the retroreflection portion in the air floating video information display system according to one embodiment of the present invention.

FIG. 9 is a diagram illustrating a fourth embodiment of the configuration of main components and the configuration of the retroreflection portion in the air floating video information display system according to one embodiment of the present invention.

FIG. 10 is an explanatory diagram for explaining an operation principle of an optical member configured to refract video light used in the air floating video information display system according to the present invention.

FIG. 11 is an explanatory diagram for illustrating a configuration and explaining principles of the air floating video information display system using the optical member configured to refract video light according to the present invention.

FIG. 12 is an explanatory diagram for explaining a configuration of the optical member configured to refract video light used in the air floating video information display system according to the present invention.

FIG. 13 is an explanatory diagram for explaining an arrangement of the optical member and a video source for preventing a viewer from directly viewing video displayed from the video source used in the air floating video information display system according to the present invention.

FIG. 14 is a cross-section view illustrating an arrangement of members configured to shield abnormal light ray caused in the retroreflection portion according to one embodiment of the present invention.

FIG. 15 is a diagram illustrating a configuration of main components of a first embodiment of the air floating video information display system according to one embodiment of the present invention.

FIG. 16 is a diagram illustrating an appearance and a configuration of main components of a second embodiment of the air floating video information display system according to one embodiment of the present invention.

FIG. 17 is a diagram illustrating an appearance and a configuration of main components of the second embodiment of another air floating video information display system according to one embodiment of the present invention.

FIG. 18 is an explanatory diagram for explaining a sensing means provided in the air floating video information display system according to one embodiment of the present invention.

FIG. 19 is a diagram illustrating other exemplary specific configuration of a light source apparatus in other system.

FIG. 20A is a configuration diagram illustrating other exemplary specific configuration of the light source apparatus in other system.

FIG. 20B is a diagram illustrating part of other exemplary specific configuration of the light source apparatus in other system.

FIG. 20C is a diagram illustrating part of other exemplary specific configuration of the light source apparatus in other system.

FIG. 20D is a diagram illustrating part of other exemplary specific configuration of the light source apparatus in other system.

FIG. 21A is a configuration diagram illustrating other exemplary specific configuration of the light source apparatus in other system.

FIG. 21B is a diagram illustrating other exemplary specific configuration of the light source apparatus in other system.

FIG. 22 is an enlarged view illustrating a surface shape of other exemplary light-guide-body diffuse portion in a specific configuration in the light source apparatus.

FIG. 23 is a cross-section view illustrating an exemplary specific configuration of the light source apparatus.

FIG. 24 is a configuration diagram illustrating an exemplary specific configuration of the light source apparatus.

FIG. 25 is a perspective view, a top view, and a cross-section view illustrating an exemplary specific configuration of the light source apparatus.

FIG. 26 is a perspective view and a top view illustrating an exemplary specific configuration of the light source apparatus.

FIG. 27 is an explanatory diagram for explaining a light-source diffuse property of a video display apparatus.

FIG. 28 is an explanatory diagram for explaining light-source diffuse property of the video display apparatus.

FIG. 29 is an explanatory diagram for explaining a diffuse property of the video display apparatus.

FIG. 30 is an explanatory diagram for explaining a diffuse property of the video display apparatus.

FIG. 31 is a diagram illustrating a coordinate system for measuring visual property of a liquid crystal panel.

FIG. 32 is a diagram illustrating luminance angle property (long-side direction) of a typical liquid crystal panel.

FIG. 33 is a diagram illustrating luminance angle property (short-side direction) of the typical liquid crystal panel.

FIG. 34 is a diagram illustrating contrast angle property (long-side direction) of the typical liquid crystal panel.

FIG. 35 is a diagram illustrating contrast angle property (short-side direction) of the typical liquid crystal panel.

FIG. 36 is explanatory a diagram for explaining a configuration preventing a decrease in performance due to moisture absorption caused by retroreflection according to one embodiment of the present invention.

FIG. 37 is an explanatory diagram for explaining a configuration of an automatic vending machine on which the air floating video information display system according to one embodiment of the present invention is mounted.

FIG. 38 is a configuration diagram of other exemplary specific configuration of the light source apparatus in other system.

FIG. 39 is a schematic diagram illustrating part of an exemplary specific configuration of a cooling means in the light source apparatus in other system.

FIG. 40 is a characteristic diagram illustrating effects of the cooling means in the light source apparatus in other system.

FIG. 41 is a diagram illustrating a fifth embodiment of a configuration of main components and a configuration of the retroreflection portion in the air floating video information display system according to one embodiment of the present invention.

### DETAILED DESCRIPTION OF PREFERRED EMBODIMENTS

Hereinafter, embodiments of the present invention will be explained in detail with reference to the drawings. Note that the present invention is not limited to contents of embodiments (also referred to as “present disclosure”) explained below. The present invention also covers the invention's spirit, the scope of the technical idea described in claims, or equivalents. The configuration of the embodiment (example) explained below is only one example, and can be variously modified and altered within the scope of the technical idea disclosed in the present specification by the person skilled in the art.

The components having the same or similar function are denoted with the same reference sign through the drawings for explaining the present invention, and the different name is appropriately used. On the other hand, the repetitive explanation for the function and others may be omitted. In the following explanation for the embodiments, note that the floating image in air is expressed as a term “air floating image”. In place of this term, this may be expressed as “spatial image”, “air (aerial) image”, “spatial floating image”, “air floating optical image of display image”, “spatial floating optical image of display image” or others. The term “aerial floating image” mainly used in the explanation for the embodiments is used as a typical example of these terms.

The present disclosure relates to an information display system capable of, for example, transmitting a video based on video light emitted from a video light emission source having a large area, through a transparent member separating a space such as a glass of a show window or others, and displaying the video as the air floating video inside or outside a shop (space). Also, the present disclosure relates to a retroreflector used in this information display system.

According to the following embodiments, for example, high-resolution video information can be displayed above a glass surface of a show window or a light-transmittable plate member while floating in air. In this case, only normal reflection light can be efficiently reflected with respect to the retroreflector by making a divergence angle of the emitted video light small, that is, be an acute angle, and unifying the video light to have a specific polarized wave. Therefore, the light use efficiency is high, and the ghost image occurring in addition to the main air floating image can be suppressed, the ghost image being the issue of the related-art retroreflection method, and thus, a clear air floating video can be provided.

By an apparatus including the light source of the present disclosure, a new air floating image information display system being capable of significantly reducing power consumption and excellent in availability can be provided. A technique of the present disclosure can provide, for example, an in-vehicle floating video information display system being capable of displaying a visually-recognizable, that is, unidirectionality air floating video outside the vehicle through a shield glass including a front windshield glass, a rear windshield glass and a side windshield glass of a vehicle.

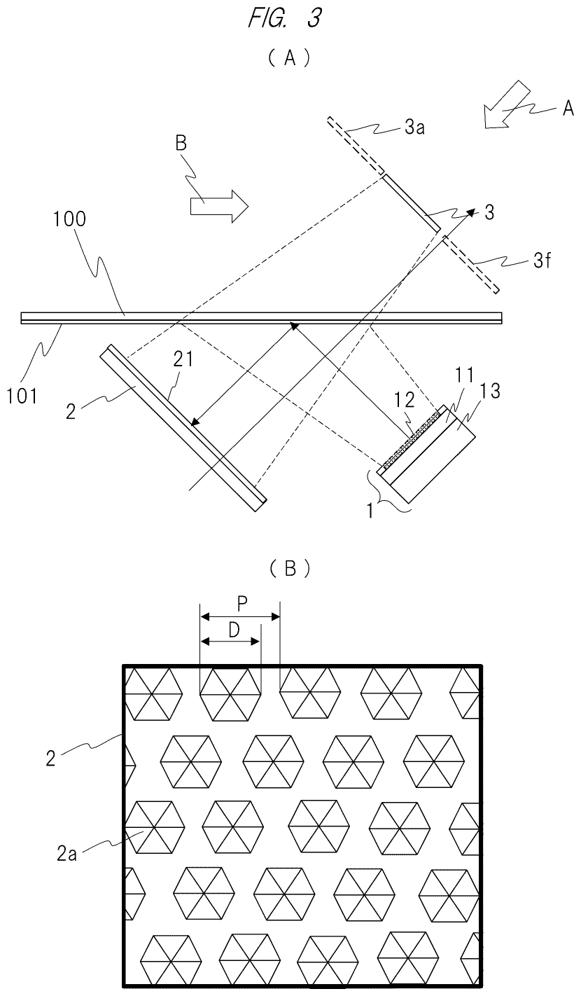

Meanwhile, in the related-art air floating video information display system, an organic EL panel or a liquid crystal display panel (liquid crystal panel or display panel) is combined with a retroreflector as a color-display video source having high resolution. In a first retroreflector 2 used in an air floating video display apparatus based on the related art, the video light diffuses at a wide angle, and therefore, six ghost images including ghost images denoted with reference signs 3a and 3f are formed by the video light obliquely entering the retroreflector since a shape used for the retroreflector 2a is a hexahedron shape in addition to the reflection light normally reflected on the retroreflector made of a polygonal body illustrated in FIG. 3 according to a first embodiment, and the ghost images reduce a quality of the air floating video. Further, other person than the viewer is undesirably allowed to view the same air floating video that is the ghost image, and this case has a large problem in a viewpoint of security.

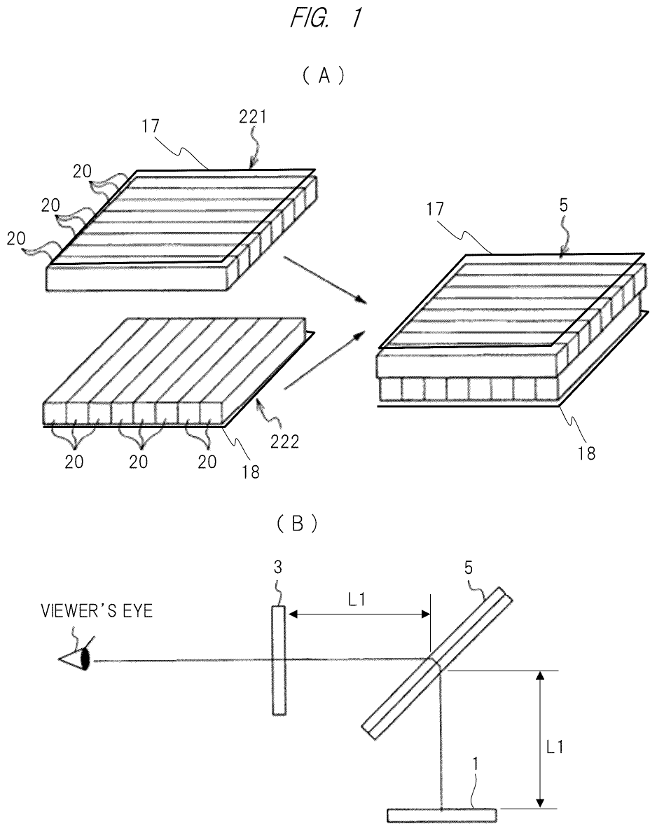

Further, in a second retroreflector 5 used in the air floating video display apparatus, as illustrated in FIG. 1A, each of a first light control panel 221 and a second light control panel 222 is formed by vertically arranging optical members 20 with many belt-shaped plane light reflection portions at a certain pitch on one side of each of transparent plates 18 and 17 with constant thickness. Here, the light reflection portions of the optical members 20 configuring the first light control panel 221 and the second light control panel 222 are arranged to cross (in this example, to be orthogonal) in plan view.

Next, functions of the second retroreflector used in the air floating video display apparatus and specific embodiments of the air floating video display apparatus will be described. The second retroreflector 5 is generally tilted at an angle of 40 to 50 degrees from a video display apparatus 1 as illustrated in FIG. 1B. In this case, video light of air floating video 3 is emitted from the second retroreflector 5 at the same angle as the angle at which it enters the second retroreflector 5. At this time, the air floating video is formed to be symmetrical to the video display apparatus 1 to have the same distance away from the second retroreflector 5 as a distance L1 between the video display apparatus 1 and the second retroreflector 5.

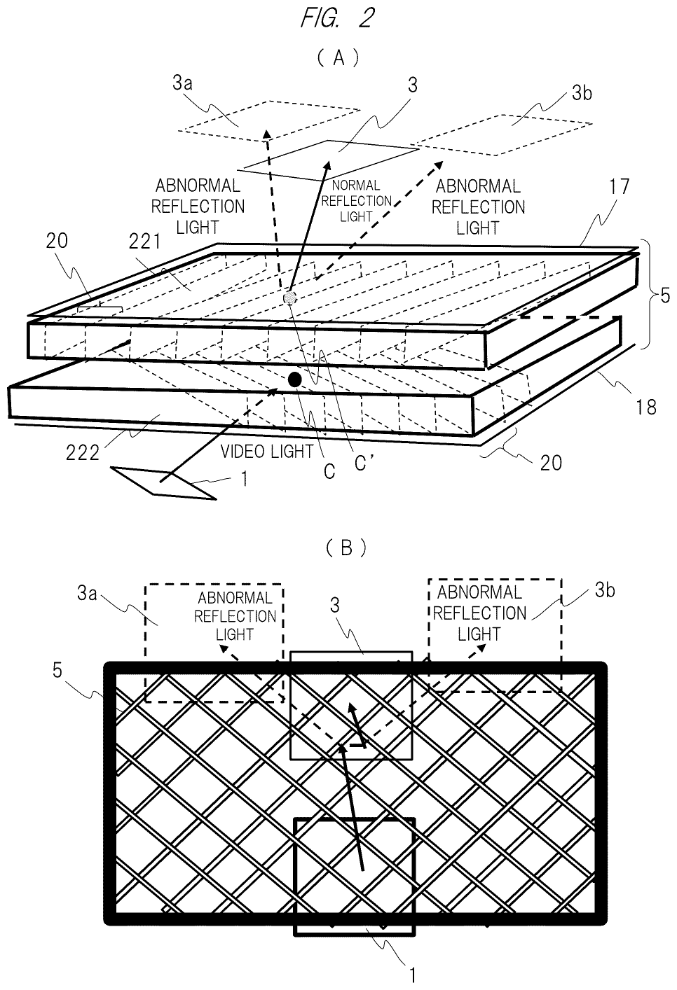

An image forming mechanism of the air floating video will be described below in detail with reference to FIGS. 1 and 2. The video light emitted from the video display apparatus 1 provided on one side of the second retroreflector 5 reflects on a plane light reflection portion C (reflection surface of the light reflector 20) of the second light control member 222, and then, reflects on a plane light reflection portion C′ (reflection surface of the light reflector 20) of the first light control member 221 to form the air floating image 3 (real image) outside the second retroreflector 5 (in space on the opposite side).

That is, the air floating video information apparatus is made of the second retroreflector 5 to display an image of the video display apparatus 1 as the air floating image in space.

Since the second retroreflector 5 has the two reflection surfaces as described above, the two ghost images 3a and 3b depending on the number of reflection surfaces are formed in addition to the air floating image 3 as illustrated in FIGS. 2A and 2B.

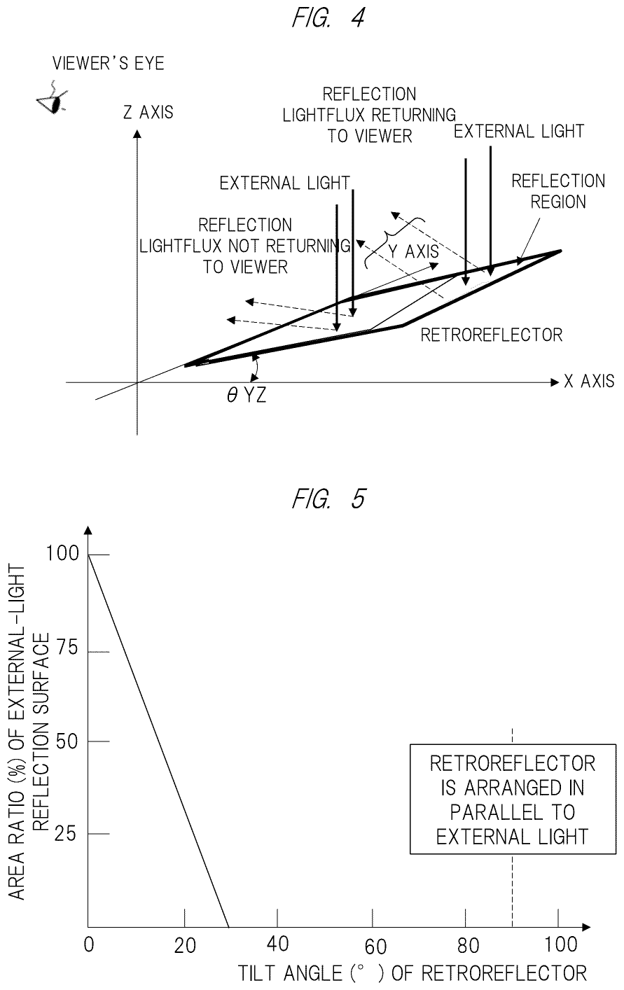

Further, as a problem, it has been found that entering of high-intensity external light from the top surface of the second retroreflector 5 makes an interval (300 μm or less) between the reflection surfaces short, and therefore, causes optical interference to be observed as iridescent-color reflection light, and makes the presence of the retroreflector recognizable for the viewer. Thus, an area of a place where the interference light is formed has been experimentally found under a measurement environment illustrated in FIG. 4 while taking an incidence angle of the external light as a parameter to prevent the interference light from returning to the viewer, the interference light being formed by the incident external light at the pitch of the reflection surface of the retroreflector 5. The obtained result is illustrated in FIG. 5. It has been found that, in assuming that the pitch between the reflection surfaces is 300 μm while a height of the reflection surface is 300 μm, the interference light does not return to the viewer when the retroreflector is tilted at a tilt angle θYZ of 35 degrees or more.

On the other hand, at a ratio (H/P) between the pitch P between the light reflectors 20 and the height H of the reflection surface, it has been found that about 60% of the reflection surface forms the air floating image based on the retroreflection while the remaining 40% thereof becomes the abnormal reflection light forming the ghost images. The pitch of the reflection surfaces absolutely needs to be reduced in order to improve resolution of the air floating video in the future. Additionally, the ratio (H/P) between the pitch P of the reflection surfaces and the height H thereof may be selected between 0.8 and 1.2 instead of the current ratio of 1.0 due to limitations in manufacturing the second retroreflector 5 although the height of the reflection surface needs to be higher than the current height in order to suppress the formation of the ghost images.

As a result of the above-described examinations, the present inventors have examined a retroreflection optical system which achieves higher image quality of the air floating video obtained by the air floating video information display system using the second retroreflector forming the less ghost image in principle, and have made the present invention. The present invention will be described below in detail with reference to the drawings.

Exemplary Configuration of First Retroreflection Optical System forming Air Floating Video Information Display System

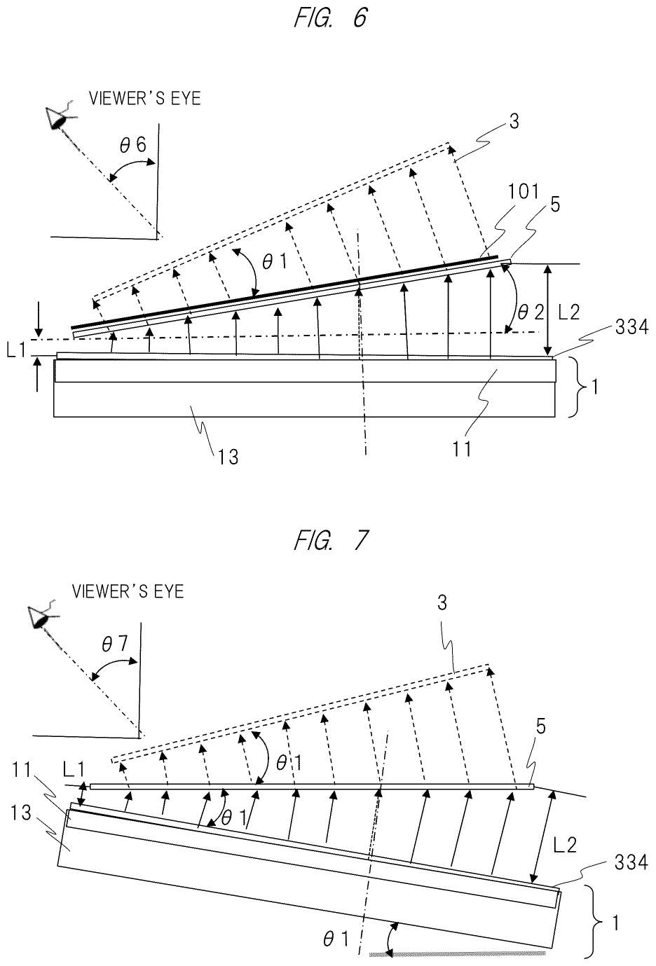

FIG. 6 is a diagram illustrating an exemplary form of a retroreflection optical system used for achieving the air floating video information display system according to the present disclosure. Further, FIG. 6 is a diagram for explaining an entire configuration of the air floating video information display system according to the present embodiment. With reference to FIG. 6, for example, in the air floating information display system (also referred to as the “present system” below) according to the present disclosure, when the air floating video information display system is arranged on a desk with respect to the viewer for the air floating video, the viewer looks down the air floating video at an angle θ6. In this case, as an optimum arrangement for viewing the air floating video, it has been found that an image forming position (angle) of the air floating image is almost equal to a sum (θ2+θ1) of an angle θ2 formed between a display surface of the video display apparatus 1 and the retroreflector 5 and an angle θ1 formed between the retroreflector 5 and the air floating image.

As described above, the air floating video is formed to be symmetrical to the video display apparatus 1 across the second retroreflector 5, and thus, the angles θ1 and θ2 which are made by the respective positions are equal. Therefore, if the angle θ6 at which the viewer looks at the air floating video display system is determined, the video display apparatus 1 and the second retroreflector 5 in the retroreflection optical system may be arranged at an angle “θ2=θ6/2”. Further, a predetermined distance L1 for enhancing cooling efficiency of the video display apparatus 1 is needed between the video display apparatus 1 and the second retroreflector 5. Further, a distance L2 relative to L1 needs to be defined in order to structurally achieve the above-described angle θ2.

A configuration of the air floating video information display system according to the present disclosure will be more specifically described. As illustrated in FIG. 6, the video display apparatus 1 configured to diverge the video light of specific polarization at a narrow angle and the second retroreflector 5 are prepared. The video display apparatus 1 includes a liquid crystal display panel (also simply referred to as liquid crystal panel below) 11 and a light source apparatus 13 configured to generate light of specific polarization with narrow-angle diffuse property.

The video light of specific polarization wave emitted from the video display apparatus 1 is selectively transmitted through an absorption-type polarization sheet 101 with an anti-reflection film prepared on a surface of the second retroreflector 5, the surface being in contact with the outside of the apparatus (not illustrated), but other polarization wave contained in the external light is absorbed by the polarization sheet, and, as a result, the reflection light reflecting on the surface of the second retroreflector 5 can be prevented from affecting the resultant air floating video.

In this case, the absorption-type polarization sheet 101 that selectively transmits the video light of the specific polarization wave has a property that transmits the video light of the specific polarization wave, and therefore, the video light of the specific polarization wave is transmitted through the absorption-type polarization sheet 101. The transmitted video light forms the air floating video 3 to be symmetric to the retroreflector 5.

Note that the light forming the air floating video 3 is aggregation of light rays converging from the retroreflector 5 to an optical image of the air floating video 3, and these light rays rectilinearly propagate even after penetrating the optical image of the air floating video 3. Therefore, the air floating video 3 is different from the diffused video light formed on a screen by a general projector or the like, and is a video having high directionality.

Therefore, in the configuration of FIG. 6, the air floating video 3 is visually recognized as a bright video when being visually recognized by a user in a direction illustrated in the drawing. However, the air floating video 3 cannot be visually recognized as a video at all when being visually recognized by a different person in up and down directions and front and back directions of the drawing sheet. This property is very preferable when being applied to a system displaying a video that needs high security or displaying a video having a high confidentiality that needs to be confidential to a person who faces the user.

Note that light polarization axes of the reflected video light are sometimes not equalized depending on a performance of the retroreflector 5. In this case, a part of the video light having the unequal light polarization axes is absorbed by the absorption-type polarization sheet 101. Therefore, unnecessary reflection light is not formed in the retroreflection optical system, and the reduction of the image quality of the air floating video can be prevented or suppressed.

Further, in the air floating video display apparatus using the retroreflection optical system according to the present disclosure, the display screen of the video display apparatus 1 is light-shielded by the reflection surface of the retroreflector 5 also when the viewer looks at the air floating video. Thus, in the air floating video display apparatus, the image displayed on the video display apparatus 1 is more difficult to be directly viewed than a case where the video display apparatus 1 faces the retroreflector.

Exemplary Configuration of Second Retroreflection Optical System forming Air Floating Video Information Display System

FIG. 7 is a diagram illustrating a configuration of main components of another exemplary retroreflection optical system for achieving the air floating video information display system according to one embodiment of the present invention. The air video information display system is suitable for the viewer who is viewing the air floating video from obliquely above. The video display apparatus 1 is made of a liquid crystal display panel 11 as a video display element and a light source apparatus 13 that generates the light of specific polarization wave having a narrow divergence property. The liquid crystal display panel 11 is made of a large liquid crystal display panel having a screen size ranging from a small screen size of about 5 inches to a large size excessing 80 inches. The video light emitted from the liquid crystal display panel 11 is emitted toward the retroreflector (retroreflection portion or retroreflection plate) 5.

The light emitted from the light source apparatus 13 of a narrow divergence angle described later is made incident on the liquid crystal panel 11 to generate a video light flux of narrow divergence angle, and the video light flux is made incident on the retroreflector 5 to form the air floating image 3. The air floating video 3 is formed to be symmetrical to the video display apparatus 1 across the retroreflector 5 serving as a symmetrical surface. In order to eliminate the ghost images generated in this case to provide the high-quality air floating video 3, the emission side of the liquid crystal display panel 11 is provided with a video light control sheet 334 having a structure illustrated in FIG. 12A to control the divergence property in unnecessary direction. Further, a reflectance of the reflector member such as the retroreflector for the video light emitted from the liquid crystal display panel 11 can be increased in principle, and therefore, a S-polarization wave may be used. However, if the viewer uses polarization sunglasses, the air floating video is reflected or absorbed by the polarization sunglasses. Therefore, in order to take measures against this, a depolarizing element 339 that optically converts a part of the video light of the specific polarization wave into the other polarization wave to be virtually converted into natural light is provided. As a result, even if the viewer uses the polarization sunglasses, the user can view the favorable air floating video. These members that are optically connected by an adhesive 338 does not generate the light reflection surface, and therefore, does not reduce the image quality of the air floating video.

As commercially available products of the depolarizing element, COSMOSHINE SRF (manufactured by Toyobo Co., Ltd) and a depolarizing adhesive (manufactured by Nagase (sangyo) & Co., Ltd) are exemplified. In the case of COSMOSHINE SRF (manufactured by Toyobo Co., Ltd), when the adhesive is adhered on the video display apparatus, the reflection on the interface can be reduced to improve the luminance. In addition, in the case of the depolarizing adhesive, the depolarizing adhesive is used so that a colorless transparent plate and the video display apparatus are adhered to each other through the depolarizing adhesive. The image emitting surface of the retroreflector 5 is also provided with a video light control sheet 334 to eliminate the ghost images formed on both sides of the normal image of the air floating video 3 due to the unnecessary light. In the present embodiment, the retroreflector 5 is arranged in parallel with a horizontal plane in space such that the air floating video 3 can be displayed to be tilted by θ1 from the horizontal plane.

Further, the video display apparatus 1 according to the present embodiment includes the liquid crystal display panel 11 and the light source apparatus 13 configured to generate the light of specific polarization having the narrow-angle diffuse property.

Exemplary Configuration of Third Retroreflection Optical System forming Air Floating Video Information Display System

FIG. 8 is a diagram n illustrating another exemplary configuration of main components of a retroreflection optical system for achieving the air floating video information display system. The air video information display system is suitable for the viewer who is viewing the air floating video from right front and obliquely above. The video display apparatus 1 is made of the liquid crystal display panel 11 as the video display element and the light source apparatus 13 that generates the light of specific polarization wave having the narrow-angle diffuse property. The liquid crystal display panel 11 is made of a large liquid crystal display panel having a screen size ranging from a small screen size of about 5 inches to a large size excessing 80 inches.

The video light emitted from the liquid crystal display panel 11 is emitted toward the retroreflector 5. The light emitted from the light source apparatus 13 of the narrow divergence angle described later is made incident on the liquid crystal panel 11 to generate a video light flux of narrow divergence angle, and the video light flux is made incident on the retroreflector 5 to form the air floating image 3. The air floating video 3 is formed to be symmetrical to the video display apparatus 1 across the retroreflector 5 serving as a symmetrical surface.

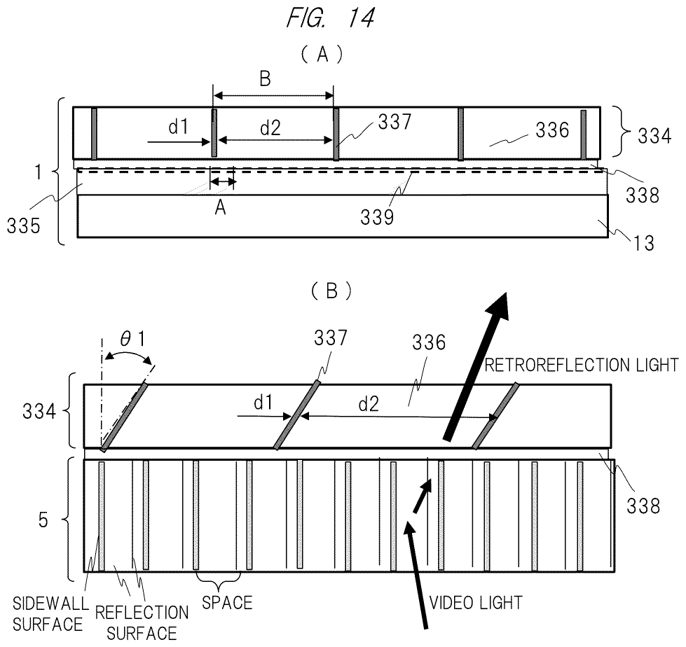

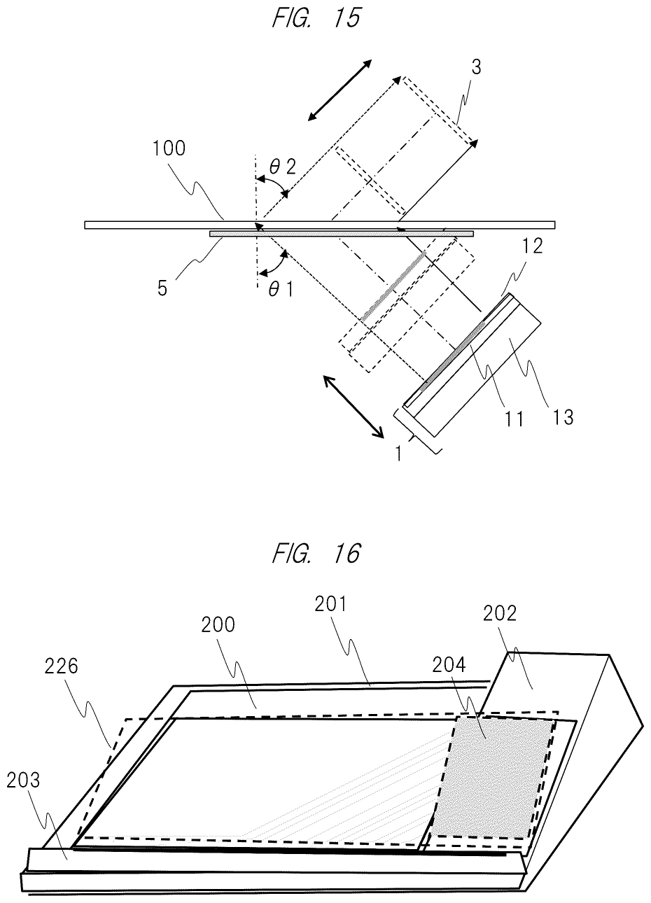

In order to eliminate the ghost images generated in the air floating video 3 to provide the high-quality air floating video 3, the emission side of the liquid crystal display panel 11 illustrated in FIG. 14A is provided with the video light control sheet 334 to control the divergence property in unnecessary direction. On the other hand, as illustrated in FIG. 14B, the image emitting surface of the retroreflector 5 may be also provided with the video light control sheet 334 to eliminate the ghost images formed on both sides of the normal image of the air floating video 3 due to the unnecessary light. When the retroreflection sheet 5 is tilted (by θ2) from the horizontal plane, the air floating image 3 can be formed at the angle θ1 from the horizontal plane. Thus, when the configuration of FIG. 8 is mounted on, for example, an upper portion of a KIOSK terminal to display the air floating video serving as an avatar on the upper end portion of the terminal, the video light travels toward eyes of the viewer, and therefore, the viewer can view the high-luminance air floating video.

In order to obtain the air floating video 3 at desired elevation angle and position, the tilt angle θ2 of the retroreflector 5 and a tilt angle θ3 of the video display apparatus 1 may be designed at optimum positions, respectively, as similar to the first and second embodiments.

Exemplary Configuration of Fourth Retroreflection Optical System forming Air Floating Video Information Display System

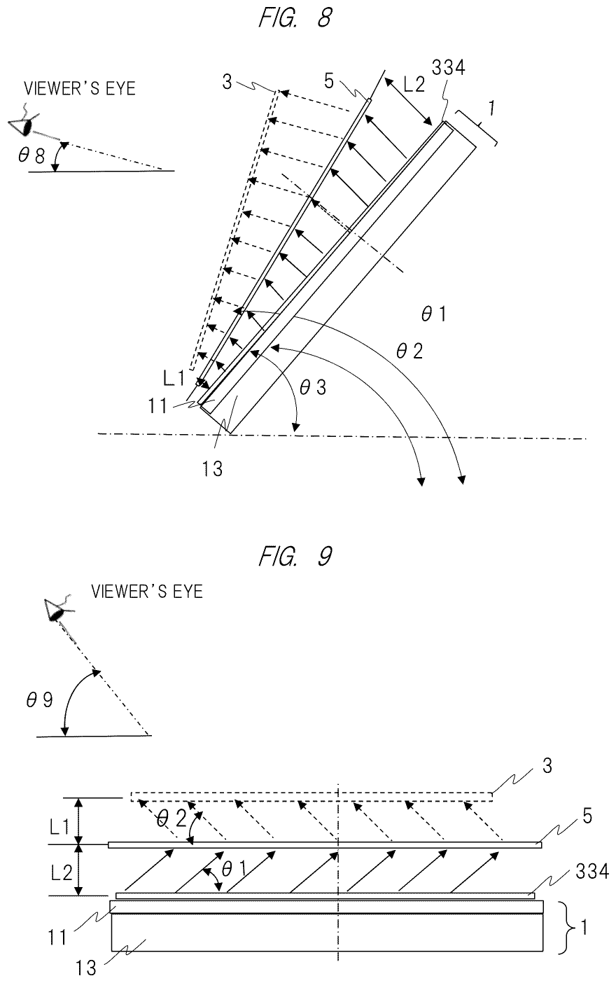

FIG. 9 is a diagram illustrating configuration of main components of another exemplary retroreflection optical system for achieving the air floating video information display system. The air video information display system is suitable for the viewer who is viewing the air floating video from obliquely above.

The video display apparatus 1 is made of the liquid crystal display panel 11 as the video display element and the light source apparatus 13 that generates the light of specific polarization wave having the narrow-angle diffuse property. The liquid crystal display panel 11 is made of a large liquid crystal display panel having a screen size ranging from a small screen size of about 5 inches to a large size excessing 80 inches.

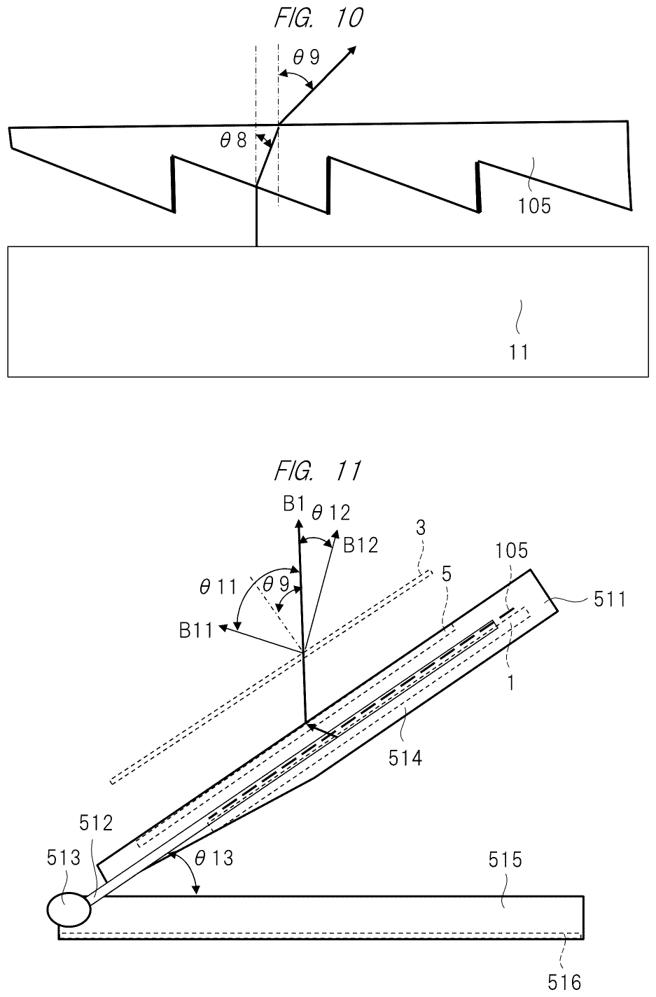

In order to make the video light emitted from the liquid crystal display panel 11 obliquely incident on the retroreflector 5 arranged at a facing position, a linear Fresnel sheet 105 serving as the video light control sheet 334 as illustrated in FIG. 10 may be arranged near the video display surface of the liquid crystal panel 11 in the video display apparatus 1 to refract the video light in a desired direction. At this time, when a light shielding layer is provided on a vertical surface of the linear Fresnel to shield the incident video light from other portions than the Fresnel lens, the unnecessary light can be suppressed. Further, when an anti-reflection film is provided on video-light entering and emitting surfaces of the linear Fresnel sheet, the unnecessary light can be suppressed to provide a favorable property.

The light is emitted toward the retroreflector 5 by the video light control sheet 334 including the linear Fresnel sheet 105. The light emitted from the light source apparatus 13 of narrow divergence angle described later is made incident on the liquid crystal panel 11 to generate the video light flux of narrow divergence angle. The video light flux is made incident on the retroreflector 5 to form the air floating image 3. The air floating image 3 is formed to be symmetrical to the display surface of the video display apparatus 1 across the retroreflector 2 serving as the symmetrical surface. In the present embodiment, the retroreflector 5 and the video display apparatus 1 are arranged to face each other. Therefore, when the viewer looks at the retroreflector 5 of the air floating video information display apparatus, the video displayed on the liquid crystal panel 11 overlaps with the air floating video to remarkably decrease the image quality of the air floating video.

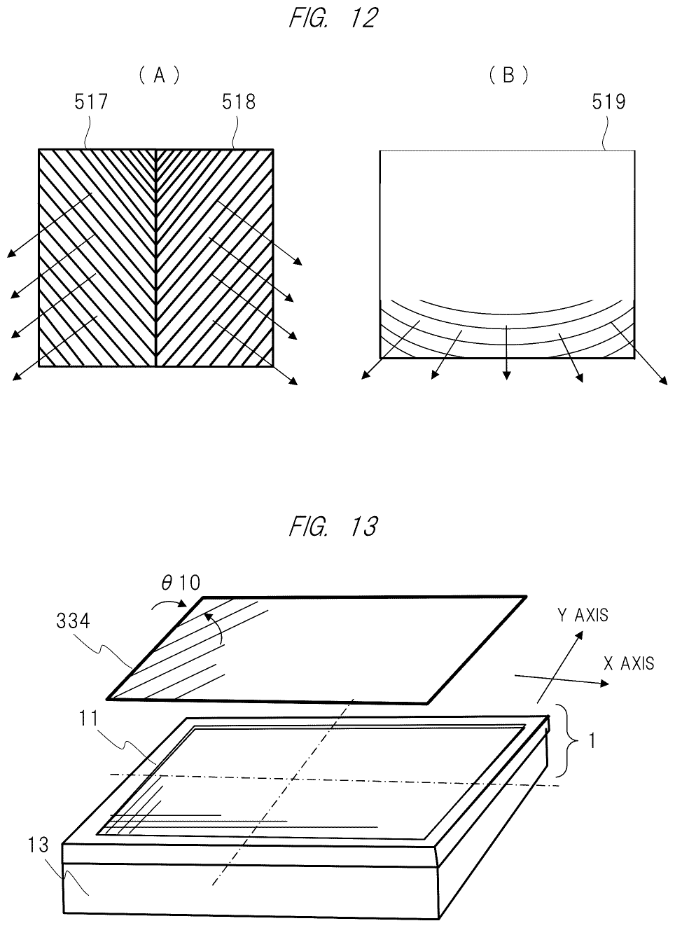

The video light control sheet is provided on the video light emission surface of the liquid crystal panel 11 in order to prevent the overlapping between the video light and the air floating video. For the video light control sheet, for example, a viewing-angle control film (VCF) manufactured by Shin-Etsu Polymer Co., Ltd., is suitable, and a structure of the VCF has a sandwich structure in which transparent silicon and black silicon are alternately arranged while the light entering/emitting surface is provided with a synthetic resin. Therefore, the same effect as that of the external-light control film in the present embodiment can be expected. The viewing-angle control film (VCF) in this case has the structure in which the transparent silicon and the black silicon extending in a predetermined direction are alternately arranged, and therefore, the extending direction of the transparent silicon and the black silicon in the video light control sheet 334 is tilted (by θ10 in the drawing) from the vertical direction of the array direction of pixels of the liquid crystal panel 11 as illustrated in FIG. 13 to reduce moire occurring at the pitches of the pixels and the external light control film.

In the fourth embodiment, the retroreflector 5 is arranged in parallel with a bottom surface of a housing. This results in the decrease in the image quality of the formed air floating video 3 since the external light is made incident on the retroreflector 5 and enters the housing. In order to eliminate the ghost images to provide the high-quality air floating video 3, the emission side of the liquid crystal panel 11 may be provided with the video light control sheet 334 as illustrated in FIGS. 14A and 14B to control the diffuse property in the unnecessary directions as similar to the second and third embodiments. On the other hand, the video emission surface of the retroreflector 5 is also provided with the video light control sheet 334 to eliminate the ghost images formed on both sides of the normal image of the air floating video 3 due to the unnecessary light. The above-described components are arranged inside the housing to prevent the entering of the external light into the retroreflector 5 and the formation of the ghost images.

If it is assumed that the Fresnel angle of the linear Fresnel sheet 105 of FIG. 10 is 20 degrees while a base material of the linear Fresnel sheet 105 is an acrylic resin, its refractive index is 1.49, and an emission angle θ9 of the linear Fresnel sheet is 30 degrees. When the light flux emitted from the video display apparatus 1 orthogonally enters the display surface, if it is assumed that the divergence angle of the light flux is ±20 degrees, the incidence angle on the emission surface is +40 degrees at a maximum. As a result, the emission light ray angle from the linear Fresnel sheet 105 is +70 degrees at a maximum to be 1.75 times. On the other hand, when the divergence angle is −20 degrees, the incidence angle on the emission surface is 10 degrees, and the diffuse angle can be changed from 20 degrees to 30 degrees that is 1.5 times that.

Further, it has been found that the present embodiment can reduce the intensity of the ghost images 3a and 3b formed in addition to the air floating image 3 as illustrated in FIG. 2(A) and (B), in other words, can reduce the luminance of the ghost images 3a and 3b since the diffuse angle of the abnormal reflection light reflected on the retroreflector 5 is increased. The above description has been made about the configuration and effects of the optical system in which the linear Fresnel sheet 105 of FIG. 10 is arranged between the retroreflector 5 and the video display apparatus 1 in order to increase the diffuse angle and decrease the ghost images.

Next, an embodiment of the housing in which the optical system using the linear Fresnel sheet 105 is used for the air floating video information display apparatus will be explained with reference to FIG. 11. As described above, the video light flux is refracted by the function of the linear Fresnel sheet 105. At this time, an emission direction of the emission light flux emitted from the video display apparatus 1 is controlled such that the primary light ray (light ray with the highest luminance) of the light flux has a desired angle θ9 relative to the air floating video 3. In this case, as illustrated in FIG. 10, an angle θ8 after the refraction can be calculated from the incidence angle and the Fresnel angle of the linear Fresnel sheet 105 and the refractive index of the base material of the linear Fresnel sheet 105, and an emission angle θ9 on the air interface after the refraction can be also unambiguously obtained.

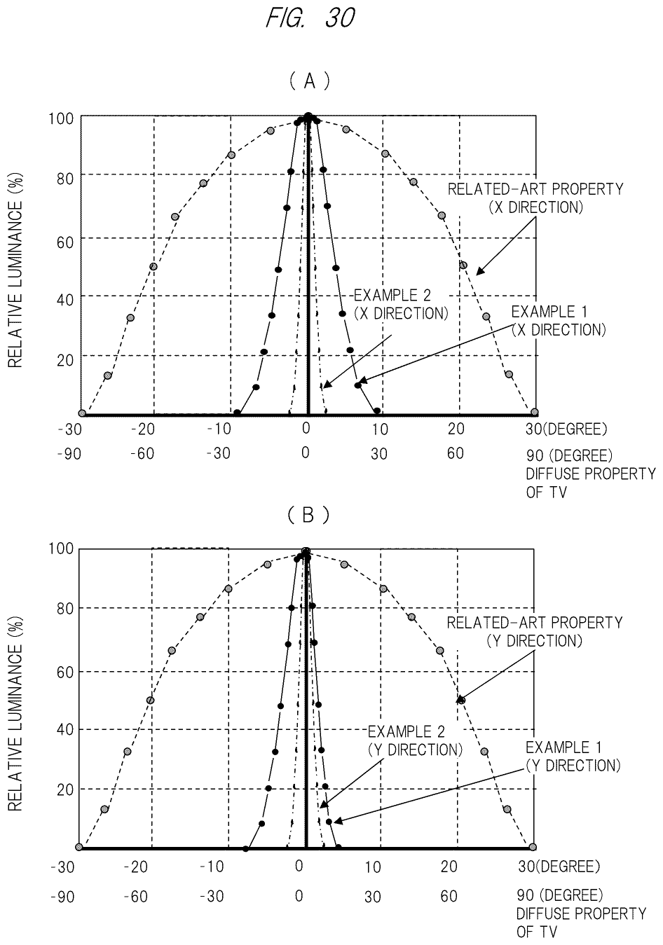

As a result, the primary light ray B1 of the video light vertically emitted from the liquid crystal display panel 11 configuring the video display apparatus 1 is obliquely refracted, enters the retroreflector 5, and is reflected on the two reflection surfaces, and then, forms the air floating video 3 to be symmetrical to the liquid crystal display panel 11. At this time, the video light flux has the narrow divergence angle because of the light source apparatus 13 (included in the video display apparatus 1 of FIG. 11) with the narrow-angle diffuse property as illustrated in FIG. 30 according to the present invention. However, a diffuse angle θ11 of one light B11 compared with the primary light ray B1 is remarkably increased by the function of the Fresnel lens sheet 105. Further, the other light B12 is diffused at a diffuse angle θ12 almost equal to the original diffuse angle.

Thus, a state with the highest luminance in the viewing of the air floating video 3 is in a case where the video is viewed in the primary light ray direction. Therefore, in order to direct the air floating video with the highest luminance in the viewing direction for the viewer, the air floating video information system with the optical system including the linear Fresnel sheet 105 is configured such that a housing base 516 as a base is provided with a hinge 513 as a mechanism to hold a housing 511 and to rotate (see an angle θ13 in FIG. 11) relative to the housing base 516, and the housing 511 is coupled to a support arm 512 while its one end is coupled to the hinge 513. As a result, the housing 511 can be held to rotate around the housing base 516, and therefore, the viewer can view the air floating video 3 with the highest luminance.

Further, because of the above mechanism, when the air floating video information display system is not in use, the housing 511 can be housed in the space between a housing cover 515 provided on the housing base 516 and the housing base 516 to achieve a compact housing form. The housing 511 houses the retroreflector 5 and the video display apparatus 1 including the liquid crystal panel (not illustrated) and the light source (not Further, a back cover 514 is provided with a illustrated). tilted surface near the hinge to prevent the back cover 514 of the housing 511 from contacting the housing base 516 at the time of the housing.

While a typical form of a linear Fresnel sheet is such that a Fresnel lens is formed in parallel with one side of the outer shape, a shape of a Fresnel lens in the first embodiment of the present invention has at least one boundary surface as illustrated in FIG. 12A. FIG. 12A illustrates the boundary surface between a tilted linear Fresnel sheet 517 and a tilted linear Fresnel sheet 518. As a result, the video light flux emitted from the video displayed on the plane display of the video display apparatus 1 arranged on the lower side of FIG. 13 is refracted in directions indicated by arrows in FIG. 12A. As a result, two light emission directions of the resultant air floating video 3 are enabled. Further, in a linear Fresnel sheet with two boundary surfaces, it is needless to say that three light emission directions of the air floating video 3 are enabled.

Further, in the second embodiment of the present invention, an eccentric Fresnel sheet 519 as illustrated in FIG. 12B has an eccentric circular Fresnel sheet structure in which the light emitted from the air floating video 3 is emitted in directions orthogonal to the Fresnel lens surface by the lens function achieved by the Fresnel shape. As a result, the video light flux emitted from the video displayed on the plane display of the video display apparatus 1 arranged on the lower side of FIG. 13 is refracted in directions indicated by arrows in FIG. 12B. Here, optimal design is made while the eccentricity and the Fresnel angle of the circular Fresnel sheet are used as parameters in order to control the light emitted from the air floating video 3. Further, when the Fresnel angles of the linear Fresnel sheet and the circular Fresnel sheet are made constant, both the control for the emission light and the thinning of the optical system set can be achieved.

The above description has been made about the technical mans for controlling the emission directions of the video light flux emitted from the video display apparatus 1 by using the function of the Fresnel lens. However, it is needless to say that the similar effects can be also provided by controlling the emission directions of the video light flux and controlling the emission directions and diffuse angles of the light emitted from the air floating video by the electrical change of the refractive index or the shape. Further, as described later, the similar effects can be also provided by controlling the emission directions of the source light flux emitted from the light source apparatus 13 and entering the liquid crystal panel 11.

### First Exemplary Configuration of Air Floating Video Information Display System

FIG. 15 illustrates a first embodiment of the air floating video information system using the four retroreflection optical systems. The retroreflector 5 is adhesively fixed or joined to a transmitting sheet 100. When a structure with a changeable distance between the video display apparatus 1 and the retroreflector 5 is made as a structure with a changeable image forming position of the air floating video 3, the air floating video can be moved to achieve the video information display apparatus capable of virtually displaying a three-dimensional air floating video.

### Second Exemplary Configuration of Air Floating Video Information Display System

A second embodiment of the air floating video information display system will be described with reference to FIG. 16. FIG. 16 illustrates a first embodiment of inclusion of a tablet terminal into an air floating video display apparatus 202. The air floating video display apparatus 202 and a plane display 200 are included in the same housing 201. Further, on the same plane as the air floating video 204, a sensing unit 203 covering all of the plane display 200 and a display image 204 of the air floating display 202 is provided at an end of the housing 201 including both the plane display 200 and the air floating video display apparatus 202. On the same plane indicated as a sensing area 226 in FIG. 16, the sensing unit 203 can sense both a sensing area of the plane display 200 and a sensing area of the air floating display 202. If the number of the sensing areas are two or more as described in the sensing area of the plane display 200 and the sensing area of the air floating display 202, note that the sensing areas may be present in parallel on the plane, present on up and down sides, or present on front and back sides. Further, the sensing areas may be present on the same plane. In this case, the sensing unit 203 may be divided for each sensing area. The air floating video display apparatus 202 and the plane display 200 may be included together in the same housing 201. The plane display 200 is used for explaining the present embodiment. However, the display is not limited to the plane display, and any display is applicable. In the second exemplary configuration, the sensing area is tiled such that the closer from the front side to the back side, a position of the sensing area is, the higher the position is. As a result, arrangement for supporting the input is achieved. The sensing unit will be described in detail later.

When a wavelength of the light-source light of a TOF system that is a ranging system of the sensing unit 203 to be used is set to a long wavelength of 900 (nm) or longer, the video information display system is less affected by the external light. In this case, a user feels as if the user can perform an air operation input, that is usually performed on the displayed air floating video 204, similarly on the video display surface of the plane display 200. Thus, the user can perform the air operation input without directly touching the display screen of the plane display 200.

Further, the present inventors have experimentally found how far from the plane display 200 to the sensing area 226 keeps an untouching state of the finger with the surface of the plane display 200 even if the operator performs the air operation on the screen displayed on the plane display 200. As a result of the experiments, it has been found that the probability of the operator's direct touching with the screen of the plane display 200 can be made to 50% or less by a distance of 40 mm or more between the plane display 200 and the image forming position of the air floating video 204. Further, the operator does not directly touch the plane display 200 by a distance of 50 mm or more therebtween.

Note that the adoption of the configuration of FIG. 16 is not limited to the tablet terminal as described above, and the configuration may be also included in various display apparatuses such as ATM, automatic ticket machine, kiosk terminal, and stationary display apparatus.

### Third Configuration of Air Floating Video Information Display System

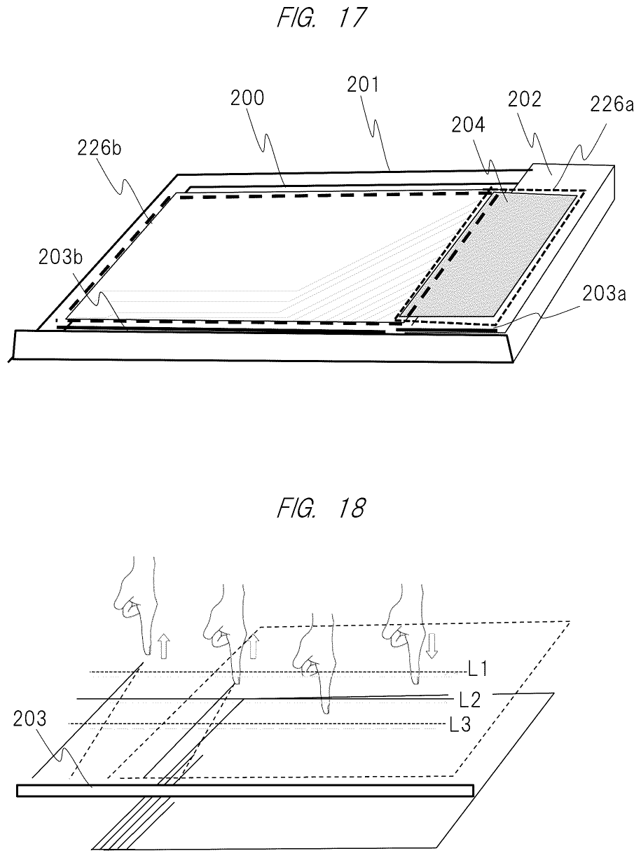

A third embodiment of the air floating video information display system will be described with reference to FIG. 17. FIG. 17 illustrates a second embodiment of the inclusion of the tablet terminal into the air floating video display apparatus 202. The air floating video display apparatus 202 and the plane display 200 are included in the same housing 201, and there are a first sensing unit 203a sensing a first sensing area (sensing region) 226a covering an image forming area of the air floating video 204 of the air floating video display apparatus 202 and a second sensing unit 203b sensing a second sensing area 226b covering an image displaying area of the plane display 200. The first sensing area 226a and the second sensing area 226b are provided at points of origin of the air floating video display apparatus 202 and the plane display 200, respectively. Further, the first sensing area 226a and the second sensing area 226b are arranged to be close to each other. The first sensing area and the second sensing area may be present in parallel on the plane or present on front and back sides. As illustrated in FIG. 17, the first sensing area and the second sensing area may be present on the same plane. The air floating video display apparatus 202 and the plane display 200 may be included together in the same housing 201. The plane display 200 is used for explaining the present embodiment. However, the display is not limited to the plane display, and any display is applicable. In the present embodiment, the sensing area are arranged in substantially parallel to the video display surface of the plane display 200. The sensing unit used in this case will be also described in detail later.

Also in the third embodiment of the video information display system, the user feels as if the user can perform the air operation input, that is usually performed on the displayed air floating video 204, similarly on the video display surface of the plane display 200. Thus, the user can perform the air operation input without directly touching the display screen of the plane display 200.

In this regard, as a result of evaluation for the finger touching with the plane display 200 under use of a prototype apparatus, it has been found that a distance of 50 mm or more between the plane display 200 and the image forming position of the air floating video 204 enables the operator to perform the air operation input on the video information display system without directly touching the screen of the plane display 200.

As similar to the above description, note that the adoption of the configuration of FIG. 17 is not limited to the tablet terminal, and the configuration may be also included in various display apparatuses such as ATM, automatic ticket machine, kiosk terminal, and stationary display apparatus.

### Technical Means for Sensing Air Video

A sensing technique for virtually operating the air floating video in order to enable the viewer (operator) to be bidirectionally connected to the information system via the air floating video display apparatus will be described below.

In the air floating video information system, when a two-dimensional sensor described later reads sensing information together with the air floating video, the image operation can be performed to the displayed video.

The sensing technique for virtually operating the air floating video in order to enable the viewer (operator) to be bidirectionally connected to the information system via the air floating video display apparatus will be described below. FIG. 18 is a principle diagram for explaining the sensing technique. A ranging apparatus 203 including a time of flight (TOF) system corresponding to the air floating video is provided. A near-infrared light emitting diode (LED) that is a light source is caused to emit light in synchronization with a signal of the system. A light emission side of the LED is provided with an optical element for controlling the divergence angle, and a pair of high-sensitivity avalanche diodes having picosecond time resolution as light receivers are aligned in a horizontal direction so as to correspond to the areas. A phase shift At is caused to correspond to time taken from the light emission of the LED that is the light source in synchronization with the signal from the system through the reflection of the light by an object (that is the finger tip of the viewer) to be measured in distance to the return of the reflection light to the light receiver. The position and motion of the operator's finger are sensed by combination of the distance of the object calculated from this time difference At and the position information of the parallel-arranged plural sensors as the two-dimension information.

### Technical Means for Reducing Ghost Image

A technical means for achieving a high-quality air video display apparatus with less ghost images as the air floating video display apparatus will be described with reference to FIG. As illustrated in FIG. 14A, an emitting surface of the 14. liquid crystal display panel 13 may be provided with the video light control sheet 334 for controlling the divergence angle of the video light emitted from the liquid crystal display panel 13 as the video display element and controlling the divergence angle in a desired direction. Further, the light-ray emitting surface of the retroreflector, the light-ray entering surface of the same, or both surfaces of the same may be provided with the video light control sheet 334 to absorb the abnormal light forming the ghost images.

FIGS. 14A and 14B illustrate a specific method of applying the video light control sheet 334 to the air floating video display apparatus. An emitting surface of a liquid crystal display panel 335 which is the video display element is provided with the video light control sheet 334. In this case, in order to reduce the moire generated by interference between the pixel of the liquid crystal panel 11 and the pitch between the light transmitting portion 336 and the light absorbing portion 337 of the video light control sheet 334, the following two methods (1) and (2) are effective.

(1) As illustrated in FIG. 13, vertical stripes generated by the light transmitting portions and the light absorbing portions of the video light control sheet 334 are arranged to tilt by an angle θ10 from the arrangement of pixels of the liquid crystal display panel 335 (described as liquid crystal panel 11 in FIG. 15).

(2) In an assumption that the pixel dimension of the liquid crystal display panel 335 is “A” (see both arrows A in FIG. 14A) while the pitch between the vertical stripes of the video light control sheet 334 is “B” (see both arrows B in FIG. 14A), a ratio (B/A) thereof is selected to a value deviating from an integral multiple.

One pixel 339 of the liquid crystal panel is made of three arranged pixels of three colors RGB, and is typically square, and thus, the formation of the moire cannot be suppressed in the entire screen. Thus, it has been experimentally found that the tilt θ10 described in the method (1) may be optimized in a range of 5 degrees to 25 degrees in order to intentionally shift the formation position of the moire to a position at which the air floating video is not displayed. The liquid crystal panel has been described as the subject to be described for reducing the moire. However, regarding the moire formed between the retroreflector 5 and the video light control sheet 334, since the retroreflector 5 and the video light control sheet 334 are linear structures, the video light control sheet is optimally tilted with respect to the X axis as illustrated in FIG. 4 to reduce the large viewable moire with long wavelength and low frequency.

FIG. 14A is a vertical cross-sectional view of the video display apparatus 1 according to the present invention in which the video light control sheet 334 is arranged on the video light emission surface of the liquid crystal panel 335. The video light control sheet 334 is configured such that the light transmitting portion 336 and the light absorbing portion 337 are alternately arranged, and is adhesively fixed to the video light emission surface of the liquid crystal panel 335 by the adhesive layer 338.

When the WUXGA liquid crystal display panel of 7 inches (1920Δ1200 pixels) is used as the video display apparatus 1 as described above, even if one pixel (corresponding one triplet) (that is a length of both arrows A in FIG. 14A) is about 80 μm, a pitch B made of a distance d2 of the light transmitting portion of the video light control sheet 334 of 300 μm and a distance d1 of the light absorbing portion of 40 μm may be applicable when being 340 μm. By such a configuration, the sufficient transmission property can be secured while the diffuse property of the video light emitted from the video display apparatus that causes the abnormal light can be controlled, and therefore, the ghost images formed on both sides of the air floating image can be reduced.

FIG. 14B is a vertical cross-sectional view of the retroreflector according to the present invention in which the video light control sheet 334 is arranged on the video light emission surface of the retroreflector 5. The video light control sheet 334 is configured such that the light transmitting portion 336 and the light absorbing portion 337 are alternately arranged, and tilts by the tilt angle θ1 to be fitted with the emission direction of the retroreflected light. As a result, by the above-described retroreflection, the abnormal light can be absorbed while the normal reflection light can be transmitted without loss.

When the WUXGA liquid crystal display panel of 7 inches (1920×1200 pixels) is used, even if one pixel (corresponding one triplet) (that is a length of both arrows A in FIG. 14(A)) is about 80 μm, if the pitch B made of the distance d2 of the light transmitting portion of the retroreflection portion of 400 um and the distance d1 of the light absorbing portion of 20 μm is 420 μm, the sufficient transmission property can be secured while the diffuse property of the video light emitted from the video display apparatus that causes the abnormal light can be controlled, and therefore, the ghost images formed on both sides of the air floating image can be reduced.

The above-described video light control sheet 334 also prevents the external light emitted from the outside from entering the air floating video display apparatus, and therefore, contributes to improvement of reliability of the components. For the video light control sheet, for example, the viewing-angle control film (VCF) manufactured by Shin-Etsu Polymer Co., Ltd., is suitable, and the structure of the VCF has the sandwich structure in which transparent silicon and black silicon are alternately arranged while the light entering/emitting surface is provided with the synthetic resin. Therefore, the same effect as that of the external-light control film in the present embodiment can be expected.

### Performance of Liquid Crystal Panel

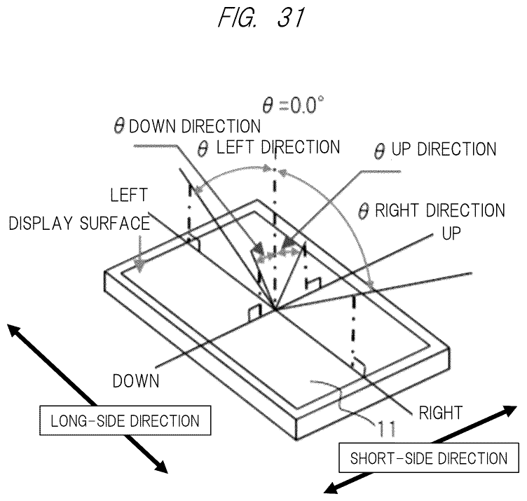

Incidentally, a general thin film transistor (TFT) liquid crystal panel has the luminance and the contrast performance depending on the light t emission direction because of the properties of both liquid crystals and a polarizer. In the evaluation under measurement environment illustrated in FIG. 31, the properties of the luminance and the viewing angle in the panel short-side (vertical) direction are excellent at an angle shifting slightly (by +5 degrees in this embodiment) from the emission angle orthogonal to the panel surface (the emission angle of 0 degree) as illustrated in FIG. 33. This is because the light twist property in the short-side (vertical) direction of the liquid crystal panel is not 0 degree at the maximum applied voltage.

On the other hand, the contrast performance in the panel short-side (vertical) direction is excellent in a range of −15 degrees to +15 degrees as illustrated in FIG. 35, and its most excellent property along with the luminance property is provided under the use in a range of ±10 degrees around 5 degrees.

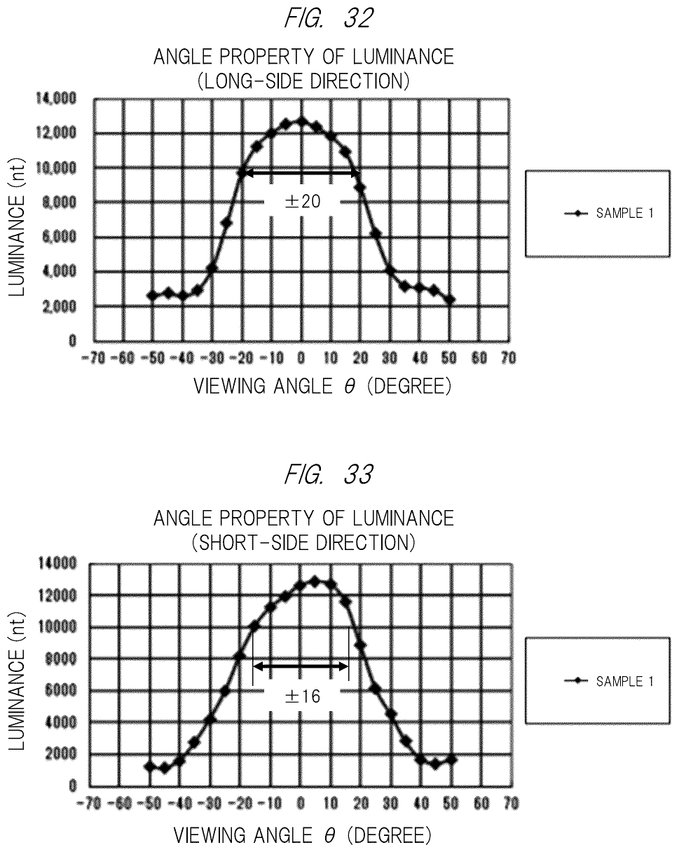

Further, the properties of the luminance and the viewing angle in the panel long-side (horizontal) direction are excellent at the emission angle orthogonal to the panel surface (the emission angle of 0 degree) as illustrated in FIG. 32. This is because the light twist property in the long-side (horizontal) direction of the liquid crystal panel is 0 degree at the maximum applied voltage.

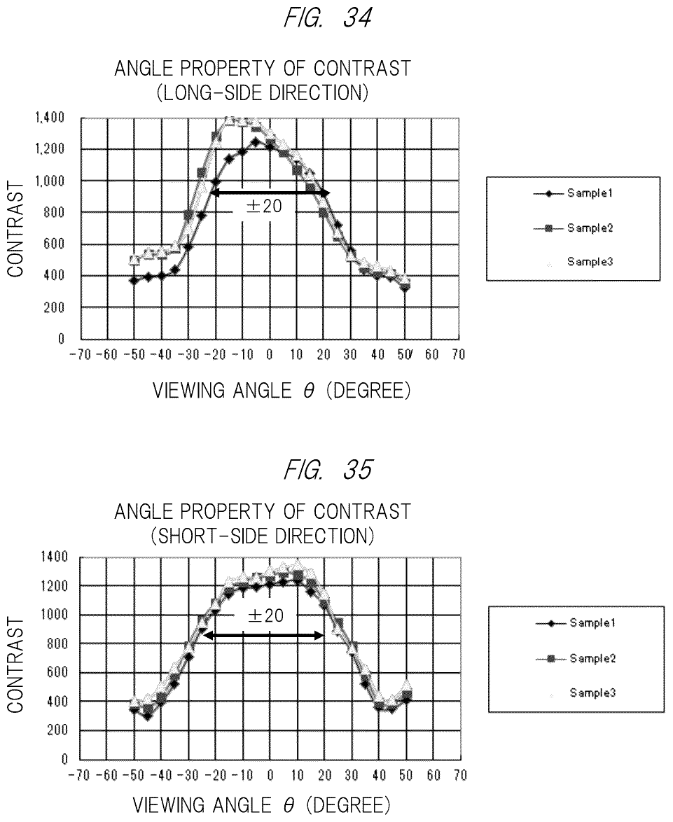

Similarly, the contrast performance in the panel long-side (horizontal) direction is excellent in a range of −5 degrees to −10 degrees as illustrated in FIG. 34, and its most excellent property along with the luminance property is provided under the use in a range of +5 degrees around −5 degrees. Thus, as the emission angle of the video light emitted from the liquid crystal panel, the light is made incident on the liquid crystal panel in a direction in which the most excellent property is achieved by a light-flux direction converter (such as reflection surfaces 307 and 314) provided on the light guiding body of the light source apparatus 13, and is optically modulated by a video signal to improve the image quality and the performance of the video display apparatus 1.

When the incident light emitted from the light source into the liquid crystal panel is set in the above range in order to maximize the luminance and the contrast property of the liquid crystal panel serving as the video display element, the video quality of the air floating video can be improved.

### Method of Controlling Light-Source Light

In the present embodiment, in order to improve the use efficiency of the emission light flux emitted from the light source apparatus 13 to remarkably reduce the power consumption, the video light ray emitted from the light source apparatus 13 of the video display apparatus 1 including the light source apparatus 13 and the liquid crystal display panel 11 is made incident on the liquid crystal panel 11 at the incidence angle maximizing the property of the liquid crystal panel 11, and then, is modulated in terms of the luminance in accordance with the video signal, and is emitted toward the retroreflector. At this time, in order to downsize a volume of the air floating video information display system set, it is desirable to increase a degree of freedom of arrangement of the liquid crystal panel 11 and the retroreflector. Further, the following technique is used for forming the floating video at a desired position after the retroreflection to secure the optimum directionality.

The video display surface of the liquid crystal panel 11 is provided with a transparent sheet made of the optical component such as the linear Fresnel lens illustrated in FIGS. 10 and 12 as the light-direction converter panel, and therefore, the emission direction of the incident light flux toward the retroreflection optical member is controlled with high directionality to determine the image forming position of the air floating video. In this configuration, the video light emitted from the video display apparatus 1 efficiently reaches the viewer while having the high directionality (rectilinear propagation) as similar to laser beam. As a result, the high-quality floating video can be displayed at high resolution, and the power consumption based on the video display apparatus 1 including the light source apparatus 13 can be remarkably reduced.

### First Exemplary Video Display Apparatus

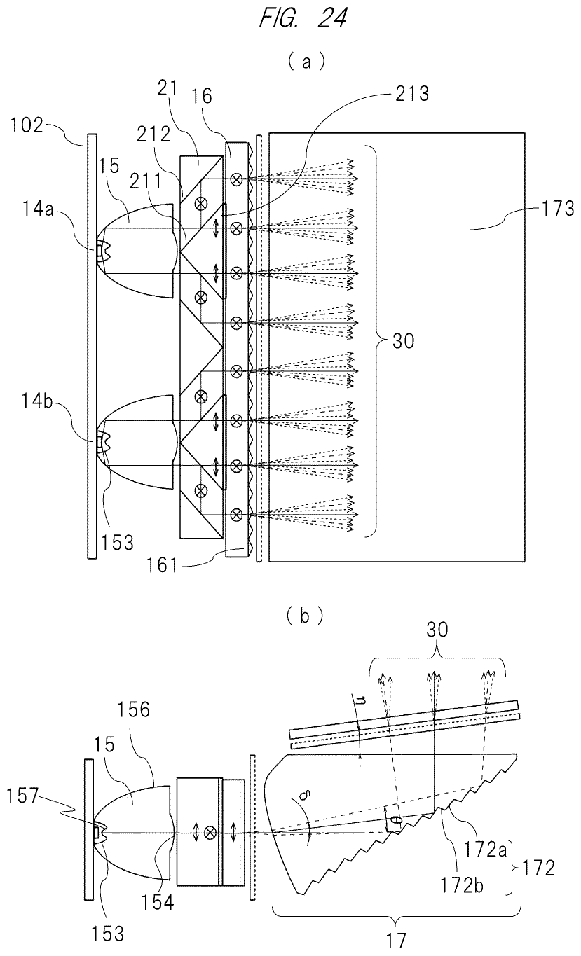

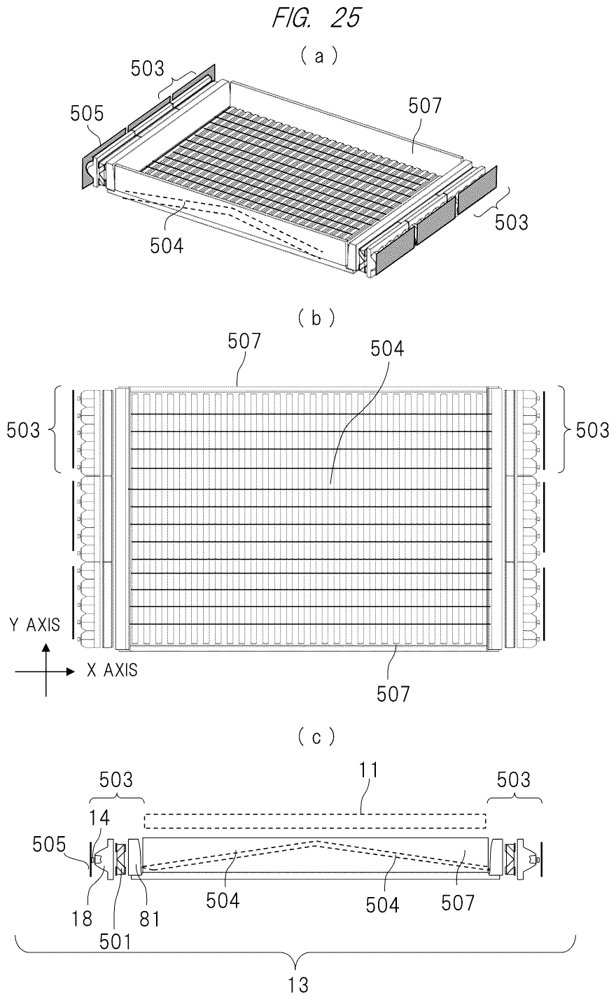

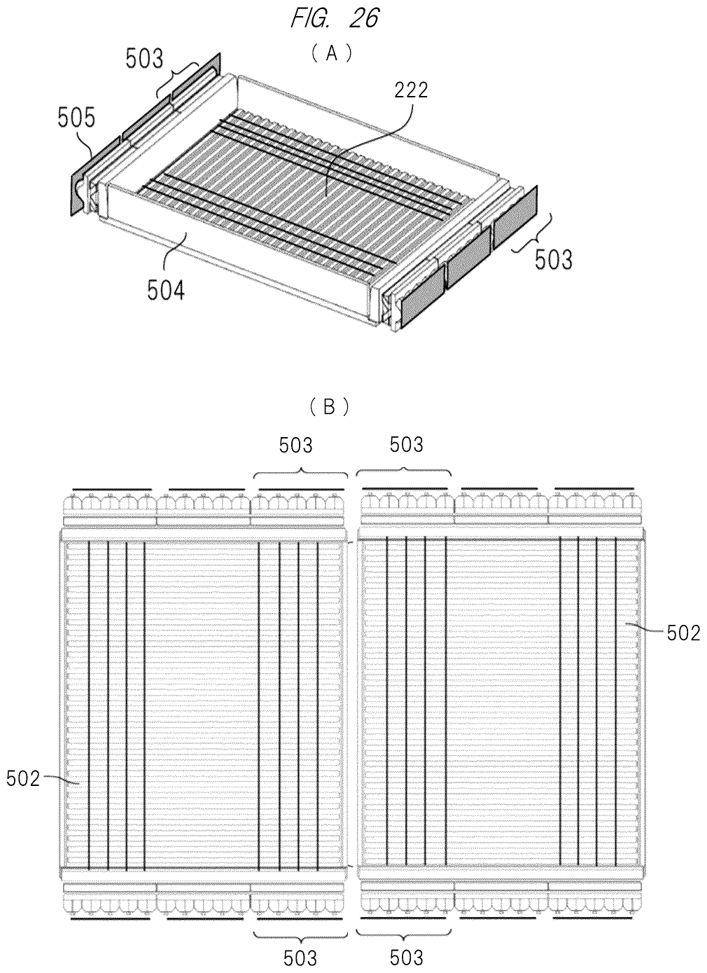

FIG. 24 shows another exemplary specific configuration of the video display apparatus 1. The light source apparatus 13 of FIG. 24 has the similar configuration to that of a light source apparatus of FIG. 25 or the like. This light source apparatus 13 is configured such that an LED, a collimator, a synthesis (composite)/diffuse block, a light guiding body and the like are housed in a case made of plastic or the like. The liquid crystal display panel 11 is attached onto an upper surface of the light source apparatus 13. An LED substrate on which light emitting diode (LEDs) elements 14a and 14b that are semiconductor light sources and a control circuit for the LED elements are mounted is attached to one side surface of the case of the light source apparatus 13 while a heat sink (not illustrated) that is a member for cooling the heat generated in the LED elements and the control circuit is attached to an outer surface of the LED substrate.

To a liquid crystal display panel frame attached to an upper surface of the case, the liquid crystal display panel 11 attached to this frame, a flexible wiring substrate (Flexible Printed Circuit: FPC) (not illustrated) electrically connected to this liquid crystal display panel 11 and others are attached. In other words, the liquid crystal display panel 11 that is the liquid crystal display element generates the display video in corporation with the LED elements 14a and 14b that are solid light sources by modulating an intensity of the transmission light on the basis of a control signal output from a control circuit (not illustrated here) configuring the electronic device.

### First Exemplary Light Source Apparatus in First Exemplary Video Display Apparatus

Subsequently, a configuration of the optical system such as the light source apparatus housed in the case will be explained in detail with reference to FIGS. 24(a) and 24(b) in addition to FIG. 23. FIGS. 23 and 24 illustrate the LEDs 14a and 14b configuring the light source, and these LEDs 102A are attached to a predetermined position of the collimators 15. Note that each of the collimators 15 is made of, for example, a light-transmittable resin such as acrylic resin. As illustrated in FIG. 24b, the collimator 15 has a conically convex outer circumferential surface 156 formed by rotation of a paraboloid cross section, and has a concave portion 153 with a convex portion (in other words, a convex lens surface) 157 at center of its apex (a side in contact with the LED substrate).

A center of a plane portion (on an opposite side of the apex) of the collimator 15 has a convex lens surface 154 that protrudes outward (or may be a concave lens surface that is recessed inward). Note that the paraboloid surface 156 forming the conically-shaped outer circumferential surface of the collimator 15 is set at an angle range allowing the light peripherally emitted from the LED elements 14a and 14b to be internally totally reflected, or forming the reflection surface.

Each of the LED elements 14a and 14b is arranged at a predetermined position on the surface of the substrate 102 that is circuit substrate. The substrate 102 is arranged and fixed so that each LED element 14a or 14b on its surface is positioned at center of the concave portion 153 to correspond to the LED collimator 15.

In such a configuration, by the collimator 15, among the light emitted from the LED element 14a or 14b, particularly the light emitted upward (in the right direction in the drawing) from its center is collected to form the collimated light by two convex lens surfaces 157 and 154 forming the outer shape of the collimator 15. The light peripherally emitted from other portions is reflected by the paraboloid surface forming the conically-shaped outer circumferential surface of the collimator 15, and is similarly collected to form the collimated light. In other words, by the collimator 15 having the convex lens formed on its center and the paraboloid surface formed on the peripheral portion, almost all the light components generated by the LED element 14a or 14b can be extracted as the collimated light, and the use efficiency of the generated light can be improved.

Note that a light emission region of the collimator 15 is provided with a polarization converter element 21. The polarization converter element 21 may be also referred to as polarization converter member. As clearly seen from FIG. 24(a), the polarization converter element 21 is made of combination of a pillar-shaped light transmittable member having a parallelogram cross section (referred to as parallelogram pillar below) and a pillar-shaped light transmittable member having a triangle cross section (referred to as triangle pillar below), and a plurality of these members are arranged in an array form in parallel to a surface orthogonal to an optical axis of the collimated light emitted from the collimator 15. Further, a polarization beam splitter (abbreviated below as PBS film) 211 and a reflection film 212 are alternately arranged at a boundary between the adjacent light transmittable members that are arranged in the array form. The emission surface from which the light having entered the polarization converter element 21 and been transmitted through the PBS film 211 is emitted includes a λ/2 waveplate 213.

The emission surface of the polarization converter element 21 is further provided with the rectangular synthesis/diffuse block 16 as shown in FIG. 24(a). In other words, the light emitted from the LED 14a or 14b is formed as the collimated light by the function of the collimator 15, enters the synthesis/diffuse block 16, and is diffused by a texture 161 on the emission side, and then, reaches the light guiding body 17.

The light guiding body 17 is a member made of a light transmittable resin such as acrylic resin and is shaped in a bar having a substantially triangle cross section (see FIG. 24(b)). As also illustrated in FIG. 23, the light guiding body 17 has a light-guiding-body light entrance portion (surface) 171 facing an emission surface of the synthesis/diffuse block 16 to interpose a first diffuse plate 18a therebetween, a light-guiding-body light reflection portion (surface) 172 forming an inclined surface, and a light-guiding-body light emission portion (surface) 173 facing the liquid crystal display panel 11 that is a liquid crystal display element to interpose a second diffuse plate 18b therebetween.

As shown in FIG. 23 that is a partial enlarge diagram of the light-guiding-body light reflection portion 172, a lot of reflection surfaces 172a and joint surfaces 172b are alternately formed in a serration form on the light-guiding-body light reflection portion (surface) 172 of the light guiding body 17. And, an angle “αn” (n: a natural number of, for example, 1 to 130 in the present example) is formed by the reflection surface 172a (a right upward line component in the drawing) and a horizontal surface illustrated with a dashed dotted line in the drawing. As its one example, the angle “αn” is set to be equal to or smaller than 43 degrees (but equal to or larger than 0 degree) here.

The light-guiding-body light entrance portion (surface) 171 is formed to have a curved convex shape being oblique toward the light source. In this manner, the collimated light emitted from the light emission surface of the synthesis/diffuse block 16 is diffused and enters through the first diffuse plate 18a, reaches the light-guiding-body light reflection portion (surface) 172 while slightly bending (being polarized) upward by the light-guiding-body light entrance portion (surface) 171 as clearly seen from the drawing, and is reflected by this light reflection portion, and reaches the liquid crystal display panel 11 arranged on the light emission surface on the upper side of the drawing sheet.

According to the video display apparatus 1 descried above, the light use efficiency and the equalized illumination property can be more improved, and the apparatus including the modularized light source for the S-polarized wave can be manufactured at a low cost to be downsized. In the above-described explanation, note that the polarization converter element 21 is attached at a subsequent stage of the collimator 15. However, the present invention is not limited to this arrangement, and the same function and effect can be provided even by arrangement of the polarization converter element 21 in middle of a light path extending to the liquid crystal display panel 11.

Note that a lot of reflection surfaces 172a and joint surfaces 172b are alternately formed in the serration form on the light-guiding-body light reflection portion (surface) 172. The illumination light flux is totally reflected on each reflection surface 172a, and propagates upward, and besides, enters a light-direction converter panel 54 for controlling the directionality as substantially collimated diffuse light flux by a narrow-angle diffuse plate arranged on the light-guiding-body light emission portion (surface) 173, and enters the liquid crystal display panel 11 in an oblique direction. The emission direction of the emission light of the video display apparatus 1 is controlled by the light-direction converter panel 54 arranged on the upper surface of the light source apparatus 13. As a result, the emission light emitted from the liquid crystal display panel 11 is also controlled, and the light diffuse direction of the resultant air floating video of the air floating video information system using the video display apparatus 1 is controlled. In the present embodiment, the light-direction converter panel 54 is arranged between the light-guiding-body emission surface 173 and the liquid crystal display panel 11. However, arrangement of the light-direction converter panel 54 on the emission surface of the liquid crystal display panel 11 can also provide the same effect.

In a general apparatus for TV, the emission light emitted from the liquid crystal display panel 11 has the same diffuse property between a screen horizontal direction (display direction corresponding to an X axis in a graph of FIG. 30(A)) and a screen vertical direction (display direction corresponding to a Y axis in a graph of FIG. 30(B)) as illustrated in, for example, plotted curves of “related-art property (X direction)” in FIG. 30(A) and “related-art property (Y direction) in FIG. 30(B).

On the other hand, the diffuse property of the light flux emitted from the liquid crystal display panel according to the present embodiment is as illustrated in, for example, plotted curves of “Example 1 (X direction)” in FIG. 30(A) and “Example 1 (Y direction)” in FIG. 30(B).

In a specific example, if a viewing angle having a luminance that is 50% of a luminance (luminance reduced to be half) of front view (angle of 0 degree) is set to 13 degrees, this angle is about ⅕ of the diffuse property (62 angle degrees) of the apparatus for general household-use TV. Similarly, for example, if a viewing angle in the vertical direction is set to unequal between the upper side and the lower side, a reflection angle of the reflection-type light guiding body, an area of the reflection surface and others are optimized so that the upper viewing angle is reduced (narrowed) to be about ⅓ of the lower viewing angle.

Since the viewing angles and the like are set as described above, an amount of the video light toward a user's viewing direction is remarkably made larger (is remarkably more improved in terms of brightness of the video) than that of the related-art liquid crystal TV, and the luminance of the video is more than 50 times.

Further, in a case of the viewing-angle property of the “Example 2” of FIG. 30, if a viewing angle having a luminance that is 50% of a luminance (luminance reduced to be half) of front view (angle of 0 degree) is set to 5 degrees, this angle is an angle of about 1/12 (narrow viewing angle) of the diffuse property (62 angle degrees) of the apparatus for general household-use TV. Similarly, for example, if a viewing angle in the vertical direction is set to unequal between the upper side and the lower side, a reflection angle of the reflection-type light guiding body, an area of the reflection surface and others are optimized so that the viewing angle in the vertical direction is reduced (narrowed) to be about 1/12 of the related-art viewing angle.

By such setting as described above, luminance (amount) of the video light toward the viewing direction (user's viewing direction) is remarkably made larger (is remarkably more improved in terms of brightness of the video) than that of the related-art liquid crystal TV, and the luminance of the video is more than 100 times.

As described above, since the viewing angle is the narrower viewing angle, the light flux toward the viewing direction can be concentrated to remarkably improve the light use efficiency. As a result, even if the general liquid crystal display panel for TV is used, when the light diffuse property of the light source apparatus is adjusted, the luminance can be remarkably improved at equivalent power consumption to achieve the video display apparatus for the information display system for bright outdoors.

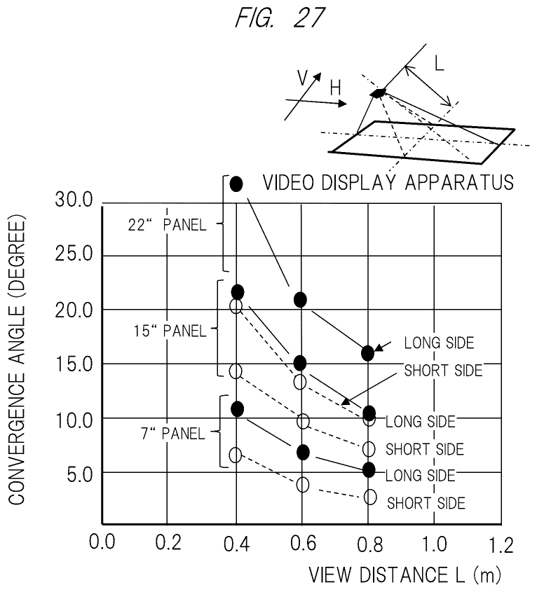

In use of a large liquid crystal display panel, when the light on the periphery of the screen is directed inward to propagate toward the viewer when the viewer faces the center of the screen, a full-screen performance in terms of the screen brightness is improved. In FIG. 27, a convergence angle made by a long side of the liquid crystal display panel and a short side of the liquid crystal display panel is found by using a distance “L” from the liquid crystal display panel to the viewer and a panel size (screen ratio (16:10)) of the video display apparatus as parameters. An upper drawing is in assumption that the video is viewed so that the screen of the liquid crystal display panel is portrait-oriented (also referred to as “vertically-long use” below). In this case, the convergence angle may be set to match with the short side of the liquid crystal display panel (see a direction of an arrow “V” in FIG. 27 as necessary).

In more specific example, with reference to the plot graph in FIG. 27, for example, if a view distance under the vertically-long use of the 22″ panel is 0.8 m, when the convergent angle is set to 10 degrees, the video light emitted from each of (four) corners of the screen can be effectively projected or output to the viewer.

Similarly, if the view distance under the vertically-long use of the 15″ panel is 0.8 m, when the convergent angle is set to 7 degrees, the video light emitted from the four corners of the screen can be effectively caused to propagate toward the viewer. As described above, depending on the size of the liquid crystal display panel or whether the use is the vertically-long use or the horizontally-long use, the video light on the periphery of the screen is caused to propagate toward the viewer at the optimal position for viewing the center of the screen, and, as a result, the full-screen performance in terms of the screen brightness can be improved.

In a basic configuration, when the light flux having the narrow-angle directionality is made incident on the liquid crystal display panel 11 by the light source apparatus as shown in FIG. 30 described above and others and is modulated in terms of the luminance in accordance with the video signal, the video information displayed on the screen of the liquid crystal display panel 11 is reflected by the retroreflector, and the resultant air floating video is displayed inside or outside the room through the transparent member 100.

A plurality of examples will be explained below as another example of the light source apparatus. All such another examples of the light source apparatus may be applicable in place of the light source apparatus of the above-described example of the image display apparatus.

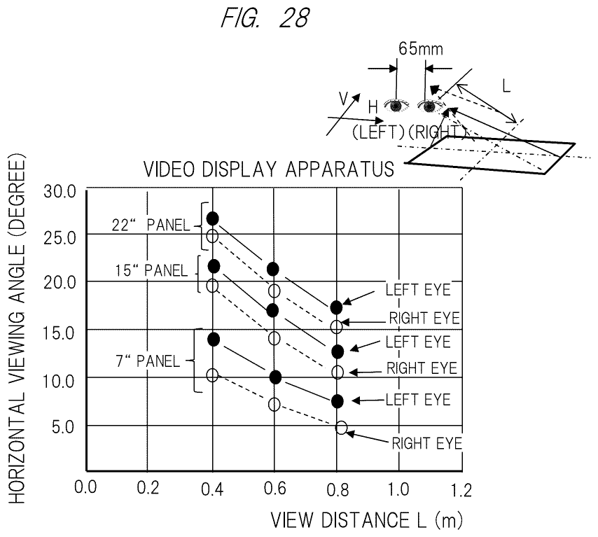

As described above, in use of the large liquid crystal display panel, when the light on the periphery of the screen is directed inward to propagate toward the viewer when the viewer faces the center of the screen, the full-screen performance in terms of the screen brightness is improved. On the other hand, binocular disparity is caused depending on viewing by either right or left eye of the viewer. In FIG. 28, a convergent angle made by a long side of the liquid crystal display panel and a short side of the liquid crystal display panel is found with respect to positions of the right and left eyes by using a distance “L” from the liquid crystal display panel to the viewer and a panel size (screen ratio 16:10) of the video display apparatus as parameters.

The smaller the panel size is, or, the smaller (closer) the viewing distance is, the larger the convergent angle in the binocular disparity using both right and left eye is. Particularly in use of a small panel of 7 inches or smaller, the convergent angle in the binocular disparity is an important factor. Therefore, in the case of, for example, 7 inches or smaller, the video light is designed to be directed in an optimum viewing range of the system by increase in the light diffuse property or the directionality of the light source of FIG. 30.

Further, depending on a required specification of the system, it is necessary to optimally design the shape, the surface roughness, the tilt, and the like of the reflection surface of the light guiding body of the light source apparatus 13 in order to achieve the horizontal and vertical directionality and the diffuse property.

### First Exemplary Light Source Apparatus

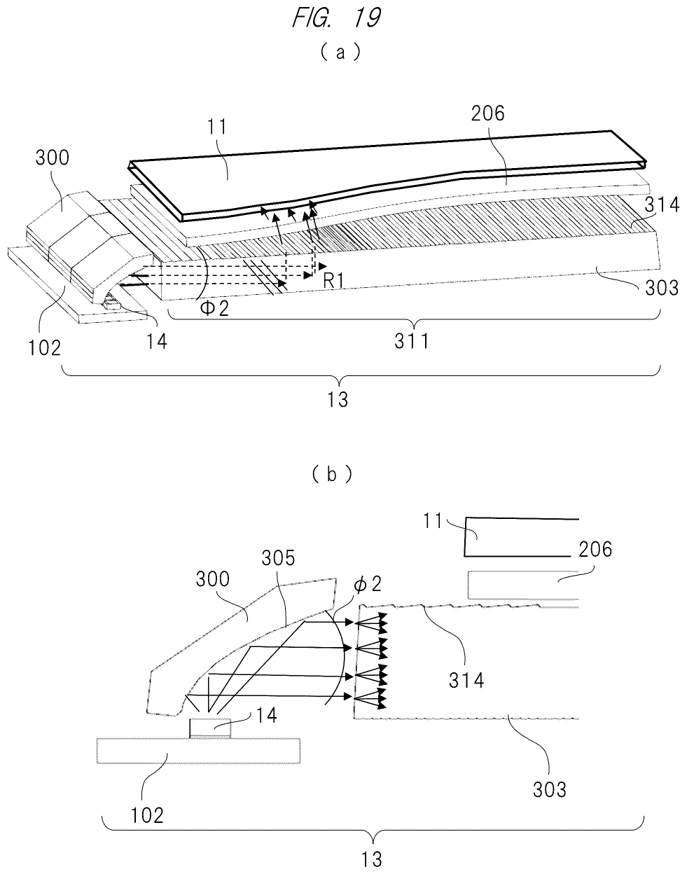

Next, with reference to FIG. 19, another exemplary light source apparatus will be explained. Each of FIGS. 19(a) and 19(b) is a diagram in which a part of the diffuse plate 206 and the liquid crystal display panel 11 are eliminated for explaining the light guiding body 311.

FIG. 19 shows a state of the substrate 102 provided with the LED 14 configuring the light source. The LED 14 and the substrate 102 are attached at predetermined positions to correspond to a reflector 300.

As shown in FIG. 19(a), the LEDs 14 are arranged on a line in parallel to the side (in this example, the short side) of the liquid crystal display panel 11 to be close to the arrangement of the reflector 300. In the illustrated example, the reflector 300 is arranged to correspond to the arrangement of the LED. Note that a plurality of the reflectors 300 may be arranged.

In a specific example, each reflector 300 is made of a plastic material. As another example, the reflector 300 may be made of a metal material or a glass material. However, since the plastic material is easier to be shaped, the plastic material is used in the present example.

As shown in FIG. 19(b), an inner (in the drawing, right) surface of the reflector 300 has a reflection surface (referred to as “paraboloid surface” below) 305 having a shape resulted from cut of a paraboloid surface at a meridional plane. In the reflector 300, the diffuse light emitted from the LED 14 is converted to the substantially collimated light by being reflected by the reflection surface 305 (paraboloid surface), and the converted light is caused to enter an end surface of the light guiding body 311. In a specific example, the light guiding body 311 is a transmission-type light guiding body.

The reflection surface of the reflector 300 has a shape that is asymmetric across an optical axis of the light emitted from the LED 14. Since the reflection surface 305 of the reflector 300 is the paraboloid surface as described above, the reflected light flux is converted to the substantially collimated light when the LED is arranged at a focal point of this paraboloid surface.

The diffuse light emitted from the LED cannot be converted to the completely collimated light even when the LED 14 is arranged at the focal point of this paraboloid surface because the LED 14 is the surface-emitting light source. However, a performance of the light source of the present invention is not affected. The LED 14 and the reflector 300 are paired. The number of the attachment of the LEDs to the substrate should be equal to or smaller than 10 in order to secure a predetermined performance when accuracy of the attachment of the LEDs to the substrate is ±40 μm, and is better to be about 5 in consideration of mass productivity.

Although the LED 14 and the reflector 300 are partially close to each other, rise of a temperature of the LED can be reduced since the heat can be released to a space near an opening of the reflector 300. Therefore, the plastic-molded reflector 300 is applicable. As a result, according to this reflector 300, the shaping accuracy of the reflection surface can be improved to be equal to or higher than 10 times of that of the glass reflector, and therefore, the light use efficiency can be improved.

Meanwhile, a base surface 303 of the light guiding body 311 is provided with a reflection surface, and the light emitted from the LED 14 is converted to the collimated light by the reflector 300, and then, is reflected by this reflection surface, and is emitted toward the liquid crystal display panel 11 facing the light guiding body 311. The reflection surface formed on the base surface 303 may have a plurality of surfaces that are different from one another in a tilt in the propagation direction of the collimated light flux emitted from the reflector 300 as shown in FIG. 19. Each surface of the plurality of surfaces that are different from one another in the tilt may have a shape extending in a direction perpendicular to the propagation direction of the collimated light flux emitted from the reflector 300.

A shape of the reflection surface formed on the base surface 303 may be a flat shape. In this case, by a refraction surface 314 formed on a surface of the light guiding body 311 facing the liquid crystal display panel 11, the light having been reflected on the reflection surface formed on the base surface 303 of the light guiding body 311 is refracted, and the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately controlled. Therefore, in the air video information display system using the video display apparatus using this light source, the diffuse direction and the diffuse angle of the video light of the air floating video can be set to desirable values.

The refraction surface 314 may include a plurality of surfaces that are different from one another in a tilt in the propagation direction of the collimated light flux emitted from the reflector 300 as shown in FIGS. 19(a) and 19(b). Each surface of the plurality of surfaces that are different from one another in the tilt may have a shape extending in a direction perpendicular to the propagation direction of the collimated light flux emitted from the reflector 300. By the tilt of each of the plurality of surfaces, the light having been reflected by the reflection surface formed on the base surface 303 of the light guiding body 311 is refracted toward the liquid crystal display panel 11. Alternatively, the refraction surface 314 may be a transmittable surface.

If the diffuse plate 206 is placed in front of the liquid crystal display panel 11, note that the light having been reflected by the reflection surface is refracted toward the diffuse plate 206 by the plurality of tilts of the refraction surface 314. In other words, an extending direction of each of the plurality of surfaces different from one another in the tilt on the refraction surface 314 and an extending direction of each of the plurality of surfaces different from one another in the tilt on the reflection surface formed on the base surface 303 are parallel. Since the both extending directions are made parallel, the angle of the light can be more preferably adjusted. Meanwhile, the LED 14 is soldered on a metallic substrate 102. Therefore, the heat generated in the LED can be released to air through the substrate.

The reflector 300 may be in contact with the substrate 102 or be spaced from it. When the space is formed, the reflector 300 is arranged to be tightly close to a housing. By the formed space, the heat generated in the LED can be released to air, and the cooling effect is enhanced. As a result, an operation temperature of the LED can be lowered, and therefore, retention of the light emission efficiency and the long life can be achieved.

### Second Another Exemplary Light Source Apparatus

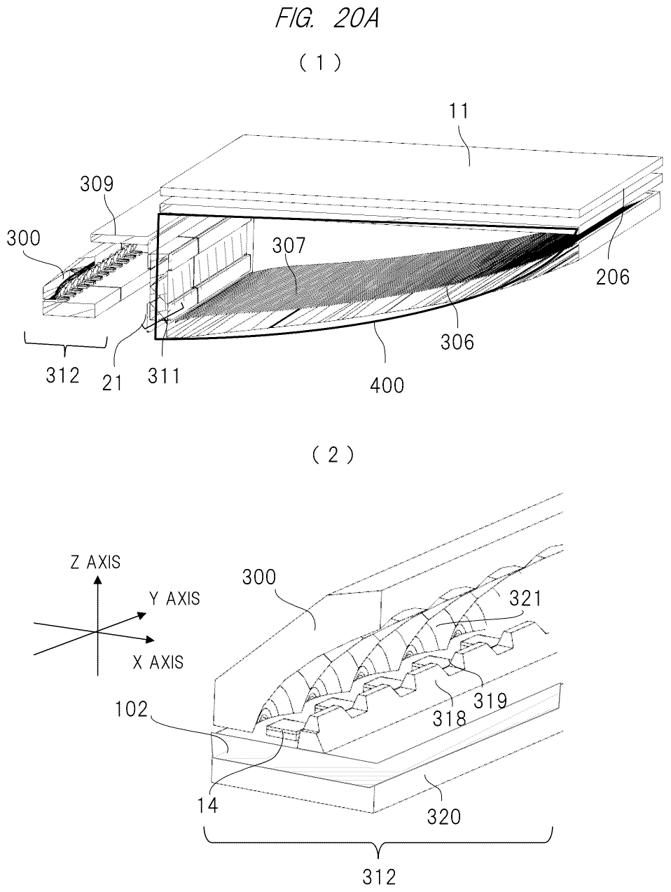

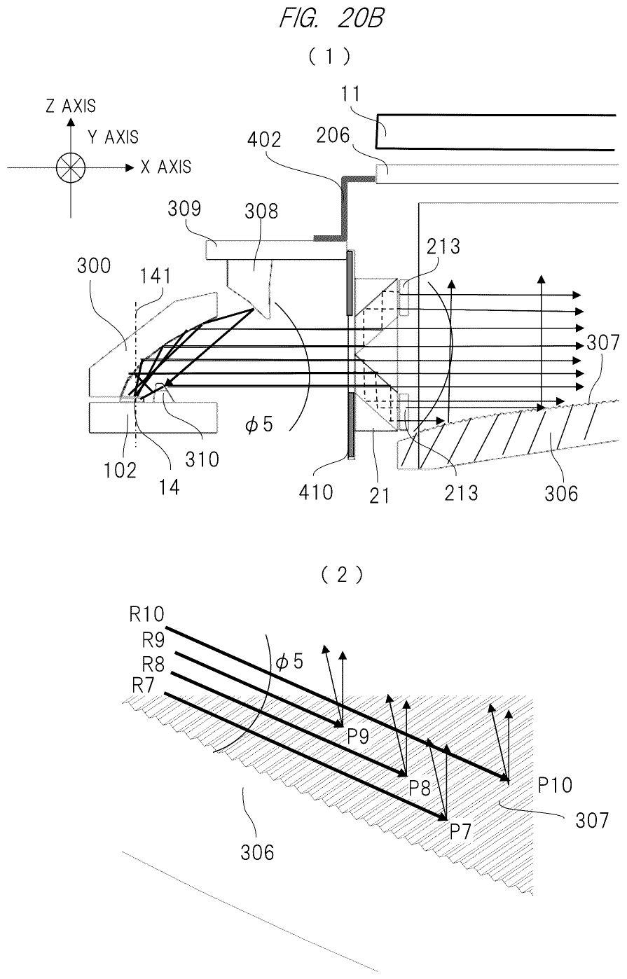

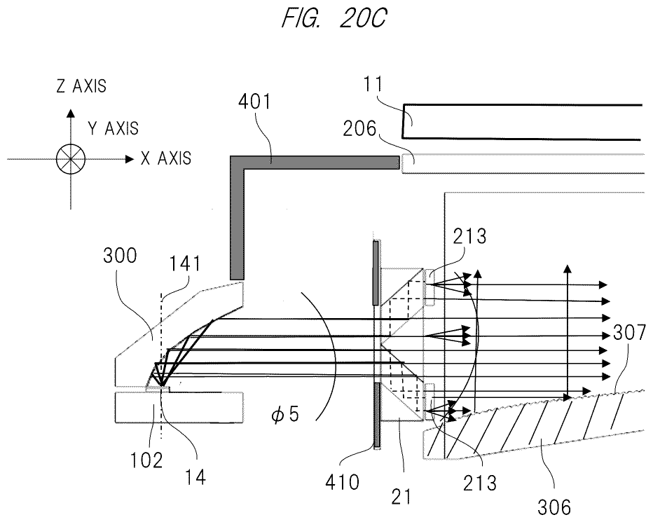

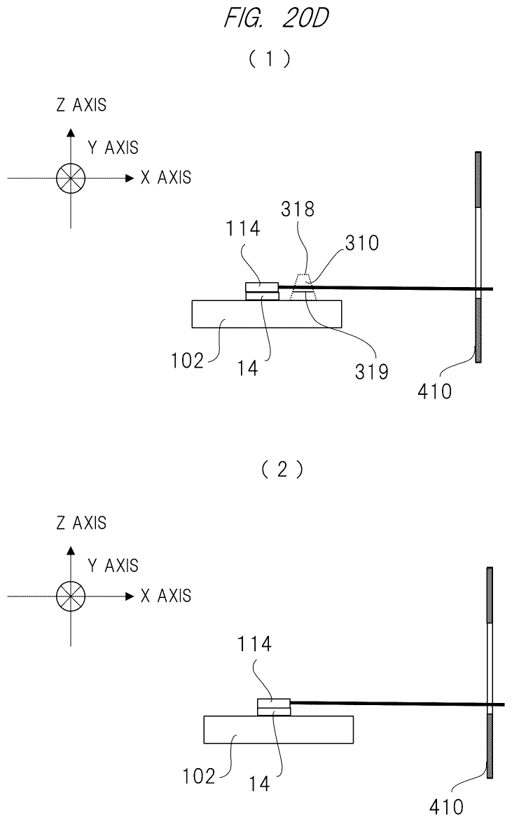

Subsequently, a configuration of an optical system regarding a light source apparatus having a light use efficiency under the usage of the light-polarization conversion that is 1.8 times better than a light use efficiency of the light source apparatus shown in FIG. 19 will be explained in detail with reference to FIGS. 20A, 20B, 20C and 20D. In FIG. 20A, note that illustration of a sub reflector 308 is omitted.

FIGS. 20, 20B and 20C illustrate the state of the substrate 102 provided with the LED 14 configuring the light source, and a unit 312 is configured to include a plurality of blocks each made of a pair of the reflector 300 and the LED 14.

Among these members, a base member 320 shown in FIG. 20A (2) is a base member of the substrate 102. Generally, the metallic substrate 102 has heat, and therefore, the base member 320 may be made of a plastic material or others in order to (thermally) insulate the heat of this substrate 102. A material and a shape of the reflection surface of the reflector 300 may be the same material and shape as those of the example of the light source apparatus of FIG. 28.

The reflection surface of the reflector 300 may have a shape that is asymmetric across the optical axis of the light emitted from the LED 14. A reason for this will be explained with reference to FIG. 20A (2). In the present example, the reflection surface of the reflector 300 is the paraboloid surface as similar to that of the example of FIG. 19, and the center of the light emission surface of the LED that is the surface-emitting light source is arranged at the focal position of the paraboloid surface.

And, because of the characteristics of the paraboloid surface, the light emitted from the four corners of the light emission surface also becomes the substantially collimated light flux, and is different in only the light emission direction. Therefore, even if the light emitting unit has an area, when a distance between the reflector 300 and the polarization converter element arranged at the subsequent stage is small, the light quantity and the conversion efficiency of the light entering the polarization converter element 21 are hardly affected.

And, even if the attachment position of the LED 14 shifts on an X-Y plane from the focal point of the corresponding reflector 300, the optical system capable of suppressing the reduction of the light conversion efficiency can be achieved because of the above-described reason. Further, even if the attachment position of the LED 14 varies in a Z-axis direction, only movement of the converted collimated light flux on a Z-X plane is caused, the accuracy of the attachment of the LED that is the surface-emitting light source can be significantly reduced. Also in the present example, the reflector 300 having the reflection surface resulted from cutting of a part of the paraboloid surface on a meridian has been explained. However, the LED may be arranged in a cut part of the entire paraboloid surface as the reflection surface.

On the other hand, as shown in FIGS. 20B (1) and 20C, the present example has a characteristic configuration in which the diffuse light emitted from the LED 14 is reflected and converted to the substantially collimated light by the paraboloid surface 321, and then, is caused to enter the end surface of the polarization converter element 21 at the subsequent stage, and is equalized to have the specific polarized wave by the polarization converter element 21. By such a characteristic configuration, the light use efficiency of the present invention is 1.8 times better than that of the example of FIG. 26, and the light source having high efficiency can be achieved.

In this case, note that all components of the substantially collimated light resulted from the reflection of the diffuse light emitted from the LED 14 by the paraboloid surface 321 are not equalized. Therefore, the angular distribution of the reflection light is adjusted by the reflection surface 307 having the plurality of tilts, and the light can be caused to enter the liquid crystal display panel 11 in the vertical direction to the liquid crystal display panel 11.

In the example of these drawings, the direction of the light (principal ray) entering the reflector from the LED and the direction of the light entering the liquid crystal display panel are arranged to be substantially parallel to each other. This arrangement is easily made in terms of the design, and arrangement of the thermal source below the light source apparatus is more preferable since the temperature increase of the LED can be decreased by the upward air release.

As shown in FIG. 20B (1), in order to improve a capture rate of the emission light emitted from the LED 14, the light flux incapable of being captured by the reflector 300 is reflected by the sub reflector 308 formed in a light shielding plate 309 above the reflector, is reflected by a tilt surface of a sub reflector 310 on a lower side, is caused to enter an effective region of the polarization converter element 21 at the subsequent stage, and the light use efficiency is further improved. In other words, in the present example, a part of the light having been reflected by the reflector 300 is reflected by the sub reflector 308, and the light having been reflected by the sub reflector 308 is reflected toward the light guiding body 306 by the sub reflector 310.

By the reflection shape on the surface of the reflection-type light guiding body 306, the substantially collimated light flux having the specific polarized wave equalized by the polarization converter element 21 is reflected toward the liquid crystal display panel 11 facing the light guiding body 306. In this case, the light-quantity distribution of the light flux entering the liquid crystal display panel 11 optimally designed by the shape and the arrangement of the reflector 300, and the reflection surface shape (cross-sectional shape), the reflection surface tilt and the surface roughness of the reflection-type light guiding body and others.

The plurality of reflection surfaces are arranged as the reflection surface shape formed on the surface of the light guiding body 306 to face the light emission surface of the polarization converter element, and the tilt of the reflection surface, the area, the height and the pitch are optimized in accordance with the distance from the polarization converter element 21, and, as a result, the light-quantity distribution of the light flux entering the liquid crystal display panel 11 is set to be a desirable value as described above.

The reflection light can be accurately adjusted when the reflection surface 307 formed on the reflection-type light guiding body is configured to have one surface with the plurality of tilts as shown in FIG. 20B (2). In such a configuration of the reflection surface having one surface with the plurality of tilts, note that a region to be used as the reflection surface may be made of a plurality of surfaces, a polygonal surface or a curved surface. Further, the light-quantity distribution can be more equalized by a diffuse function of the diffuse plate 206. The light-quantity distribution of the light entering the diffuse plate closer to the LED can be equalized by change of the tilt of the reflection surface. As a result, the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately controlled. Therefore, in the air video information display system using the video display apparatus using this light source, the diffuse direction and the diffuse angle of the video light of the air floating video can be set to desirable values.

In the present example, a plastic material such as heat-resistant polycarbonate is used for the base member of the reflection surface 307. An angle of the reflection surface 307 to which the light propagates immediately after the light emission from the λ/2 plate 213 is changed in accordance with a distance between the λ/2 plate and the reflection surface.

Also in the present example, although the LED 14 and the reflector 300 are partially close to each other, the heat can be released to the space near the opening of the reflector 300, and the temperature increase of the LED can be decreased. Alternatively, vertical arrangement order of the substrate 102 and the reflector 300 may be inversed from the arrangement of FIGS. 20A, 20B and 20C.

However, if the substrate 102 is arranged on the upper side, the substrate 102 is close to the liquid crystal display panel 11, and therefore, layout may be made difficult. Therefore, the arrangement of the substrate 102 on the lower side of the reflector 300 (to be farther from the liquid crystal display panel 11) as shown in the drawing makes the configuration in the apparatus simpler.

The light entering surface of the polarization converter element 21 may be provided with a light shielding plate 410 in order to prevent the unnecessary light from entering the optical system at the subsequent stage. By such a configuration, the light source apparatus in which the temperature increase is suppressed can be achieved. The light polarizer on the light entering surface of the liquid crystal display panel 11 can absorb the light flux having the equalized light polarization as described in the present invention to decrease the temperature increase, and the light polarizer on the entering side can absorb a part of the light having the light polarization direction rotated when being reflected by the reflection-type light guiding body. The temperature of the liquid crystal display panel 11 is also increased by the temperature increase due to the absorbance in the liquid crystals themselves and the light entering the electrode pattern. However, since there is the sufficient space between the liquid crystal display panel 11 and the reflection surface of the reflection-type light guiding body 306, the liquid crystal display panel 11 can be naturally cooled.

FIG. 20D shows a modification example of the light source apparatus of FIGS. 20B (1) and 20C. FIG. 20D (1) shows a modification example of the light source apparatus of FIGS. 20B (1) while extracting a part of the same. Configurations of other components are the same as those of the light source apparatus of FIGS. 20B (1), and therefore, illustration and repetitive explanation of the same will be omitted.

First, in the example shown in FIG. 20D (1), a height of a concave portion 319 of the sub reflector 310 is adjusted to be lower than a phosphor (fluorescent body) 114 so that fluorescence principal ray (see a straight line extending in a direction parallel to an X-axis in FIG. 20D (1)) emitted in a horizontal direction (X-axis direction) from the phosphor 114 is released out of the concave portion 319 of the sub reflector 310. Further, a height of a light shielding plate 410 in a Z-axis direction is adjusted to be lower than the position of the phosphor 114 so that the fluorescence principal ray emitted in the horizontal direction from the phosphor 114 is not shielded by the light shielding plate 410 and enters the effective region of the polarization converter element 21.

The reflection surface of the convex portion of convex and concave on the apex of the sub reflector 310 reflects the light having been reflected by the sub reflector 308 in order to guide the light having been reflected by the sub reflector 308 toward the light guiding body 306. Therefore, a height of a convex portion 318 of the sub reflector 308 is adjusted so that the light having been reflected by the sub reflector 308 is reflected and is caused to enter the effective region of the polarization converter element 21 at the subsequent stage, and, as a result, the light use efficiency can be further improved.

Note that the sub reflector 310 is arranged to extend in one direction as shown in FIG. 20A (2), and has the convex and concave shape. On the apex of the sub reflector 310, convex and concave having one or more concave portions are periodically arranged in one direction. Such a convex and concave shape achieves the configuration in which the fluorescence principal ray emitted in the horizontal direction from the phosphor 114 enters the effective region of the polarization converter element 21.

The convex and concave shape of the sub reflector 310 is periodically arranged at a pitch at which the concave portion 319 is positioned at the LED 14. In other words, each phosphor 114 is periodically arranged in one direction to correspond to the pitch of the arrangement of the concave portion of the convex and concave of the sub reflector 310. If the LED 14 includes the phosphor 114, note that the phosphor 114 may be interpreted as the light emitter portion of the light source.

FIG. 20D (2) shows a modification example of the light source apparatus of FIGS. 20C while extracting a part of the same. Configurations of other components are the same as those of the light source apparatus of FIGS. 20C, and therefore, illustration and repetitive explanation of the same will be omitted. As shown in FIG. 20D (2), the sub reflector 310 may be eliminated. However, as similar to FIG. 20D (1), the height of the light shielding plate 410 in the Z-axis direction is adjusted to be lower than the position of the phosphor 114 so that the fluorescence principal ray emitted in the horizontal direction from the phosphor 114 is not shielded by the light shielding plate 410 and enters the effective region of the polarization converter element 21.

In the light source apparatuses of FIGS. 20A, 20B, 20C and 20D, note that a sidewall 400 may be formed as shown in FIG. 20A (1) in order to prevent dusts from entering the space between the liquid crystal display panel 11 and the reflection surface of the reflection-type light guiding body 306, prevent stray light toward outside of the light source apparatus and prevent stray light from entering from the outside of the light source apparatus. When the sidewall 400 is formed, the sidewall 400 is arranged to sandwich a space between the light guiding body 306 and the diffuse plate 206.

The light emission surface of the polarization converter element 21 that emits the light having been converted in terms of the light polarization by this polarization converter element 21 faces a space surrounded by the sidewall 400, the light guiding body 306, the diffuse plate 206 and the polarization converter element 21. A reflection surface having a reflection film or others is used as a surface of inner surfaces of the sidewall 400, the surface covering, from a side surface, a space in which the light is emitted from the light emission surface of the polarization converter element 21 (the space is a right space of the light emission surface of the polarization converter element 21 of FIG. 20B (1)). In other words, the surface of the sidewall 400 facing this space has the reflection region having the reflection film. Since this portion of the inner surfaces of the sidewall 400 is used as the reflection surface, the light having been reflected by this reflection surface can be reused as the light of the light source, and the luminance of the light source apparatus can be improved.

The surface of the inner surfaces of the sidewall 400, the surface covering the polarization converter element 21 from the side surface, is formed as a surface having a low light reflectance (such as a black surface without the reflection film or others). This is because the reflection light on the side surface of the polarization converter element 21 generates the light having the unexpected light polarization state to be a cause of the stray light. In other words, when the surface is formed as the surface having the low light reflectance, the generation of the stray light of the video and the light having the unexpected light polarization state can be prevented or suppressed. Alternatively, a part of the sidewall 400 may be configured to have an air-flow hole to improve the cooling effect.

Note that the configuration using the polarization converter element 21 is a prerequisite on the explanation for the light source apparatuses of FIGS. 20A, 20B, 20C and 20D. However, a configuration in which the polarization converter element 21 is eliminated from such a light source apparatus is also applicable. In this case, such a light source apparatus can be provided at a less inexpensive cost.

### Third Another Exemplary Light Source Apparatus

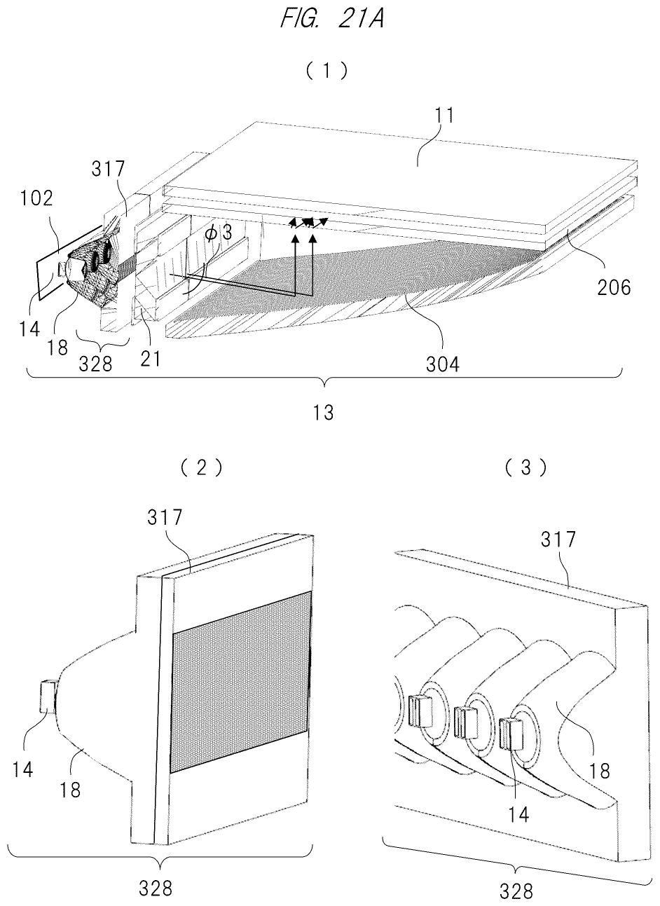

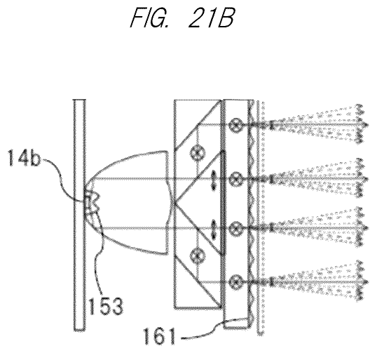

Subsequently, a configuration of an optical system regarding a light source apparatus using the reflection-type light guiding body 304 based on the light source apparatus shown in the first example of the light source apparatus will be explained in detail with reference to FIGS. 21A (1), (2) and (3) and 21B.

FIG. 21A shows a state of the substrate 102 provided with the LED 14 configuring the light source, and a unit 328 is configured to include a plurality of blocks each made of a pair of the collimator 18 and the LED 14. Since the collimator 18 of the present example is close to the LED 14, the glass material is used in consideration of the thermal resistance. A shape of the collimator 18 is the same as the shape explained in the collimator 15 in FIG. 20. And, the light shielding plate 317 is arranged at a previous stage of the entering to the polarization converter element 21, and, as a result, the unnecessary light is prevented or suppressed from entering the optical system at a subsequent stage, and the temperature increase due to the unnecessary light is reduced.

Since other configurations and effects of the light source shown in FIG. 21A are the same as those of FIGS. 20A, 20B, 20C and 20D, the repetitive explanation thereof will be omitted. In the light source shown in FIG. 21A, a sidewall may be formed as similar to those explained in FIGS. 20A, 20B and 20C. A configuration and an effect of the sidewall has been already explained, and therefore, the repetitive explanation thereof will be omitted.

FIG. 21B is a cross-sectional view of FIG. 21A (2). A configuration of a light source shown in FIG. 21B is partially in common with the configuration of the light source shown in FIG. 20, and has been already explained in FIG. 20, and therefore, the repetitive explanation thereof will be omitted.

### Fourth Another Exemplary Light Source Apparatus

Subsequently, the light source apparatus of FIG. 25 is made of a unit 328 including a plurality of blocks each made of a pair of the collimator 18 and the LED 14 used in the light source apparatus shown in FIG. 21. A configuration of an optical system regarding a light source apparatus using a reflection-type light guiding body 504 and an LED arranged on both ends of a back surface of the liquid crystal display panel 11 will be explained in detail with reference to FIGS. 25 (a), (b) and (c).

FIG. 25 shows a state of a substrate 505 provided with the LED 14 configuring the light source, and a unit 503 is configured to include a plurality of blocks each made of a pair of the collimator 18 and the LED 14. The unit 503 is arranged on both ends of the back surface of the liquid crystal display panel 11 (in the present example, three units are arranged to align in the short-side direction). The light emitted from the unit 503 is reflected by the reflection-type light guiding body 504, and is caused to enter the liquid crystal display panel 11 (illustrated in FIG. 25 (c)) facing thereto.

As shown in FIG. 25 (c), the reflection-type light guiding body 504 is separated into two blocks corresponding to the units arranged on the respective ends, and has a center portion formed to be the highest. Since the collimator 18 is close to the LED 14, the glass material is used in consideration of the thermal resistance against the heat generated in the LED 14. A shape of the collimator 18 is a shape as explained in the collimator 300 in FIG. 20.

The light emitted from the LED 14 enters a polarization converter element 501 through the collimator 18. The distribution of light entering the reflection-type light guiding body 504 at the subsequent stage is configured to be adjusted by a shape of an optical element 81. In other words, the light-quantity distribution of the light flux entering the liquid crystal display panel 11 is optimally designed by adjusting the shape and arrangement of the collimator 18, the shape and the diffuse property of the optical element 81, the shape (cross-sectional shape) of the reflection surface of the reflection-type light guiding body, the tilt of the reflection surface and the surface roughness of the reflection surface.

A plurality of reflection surfaces are arranged as the shape of the reflection surface formed on the surface of the reflection-type light guiding body 504 to face the light emission surface of the polarization converter element as shown in FIG. 25(b), and the tilt, the area, the height and the pitch of the reflection surface are optimized in accordance with a distance from the polarization converter element 501. Also, a region to be the same reflection surface (the region is a surface facing the polarization converter element) is separated to form a polygon, and, as a result, the light-quantity distribution of the light flux entering the liquid crystal display panel 11 can be set (optimized) to have a desirable value as described above. As a result, the light quantity and the emission direction of the light flux that propagates toward the liquid crystal display panel 11 are accurately adjusted. As a result, the light quantities and the emission directions of the incident light on the liquid crystal display panel 11 and the emission light emitted from the liquid crystal display panel 11 can be similarly accurately controlled. Therefore, in the air video information display system using the video display apparatus using this light source, the diffuse direction and the diffuse angle of the video light of the air floating video can be set to desirable values (see four solid-line arrows indicating the “reflection light emitted from the light guiding body” in FIG. 26).

One surface (that is a light reflecting region) of the reflection surface formed on the reflection-type light guiding body is configured to have the shape with the plurality of tilts (in the example of FIG. 25, with 14-divided surfaces with different tilts on the X-Y plane), and, as a result, the reflection light can be more accurately adjusted. And, a light shielding wall 507 is arranged in order to prevent the reflection light emitted from the reflection-type light guiding body from leaking through a side surface of the light source apparatus 13, and, as a result, occurrence of leak light that does not propagate in the desirable direction (that is the direction toward the liquid crystal display panel 11) can be prevented.

The unit 503 arranged on right and left of the reflection-type light guiding body 504 of FIG. 25 may be replaced with the light source apparatus of FIG. 20. In other words, a plurality of the light source apparatuses (the substrate 102, the reflector 300, the LED 14 and others) of FIG. 20 may be prepared, and the plurality of the light source apparatuses may be arranged at positions facing one another with reference to FIGS. 25 (a), (b) and (c).

FIG. 26 (B) shows a light source apparatus in which the units 503 of FIG. 26 (A) are arranged so that six of them are arranged on the upper side while six of them are arranged on the lower side. In the light source apparatus of FIG. 26 (B), the units 503 each including five LEDs that are laterally arranged are configured as described above, and are controlled in current by a single power supply to achieve desired luminance. Thus, as the light source apparatus configured to illuminate the liquid crystal panel, the light source luminance can be controlled for each emission region by each unit 503. The configuration of FIG.

26 includes a reflection surface 222 and a reflection surface 502 different from the reflection surface 222. The reflection surface 222 of these surfaces is a horizontal grid shape or a belt shape with a predetermined width. On the other hand, the reflection surface 502 is a vertical-horizontal grid shape. The shape of the fine grid and the tilt of the divided surface are optimally designed to achieve a desired emission-light distribution (the emission direction and the diffuse property of the emission light). As a result, even if the single light source is used for the plane display and the air floating video information apparatus shown in FIGS. 16 and 17, the light quantity and the emission direction of the light flux propagating toward the liquid crystal display panel 11 can be accurately adjusted. As a result, as similar to the two embodiments described above, the light quantities and the emission directions of the incident light on the liquid crystal display panel 11 and the emission light emitted from the liquid crystal display panel 11 can be similarly accurately controlled. Therefore, in the air video information display system using the video display apparatus using this light source, the diffuse direction and the diffuse angle of the video light of the air floating video can be set to desirable values.

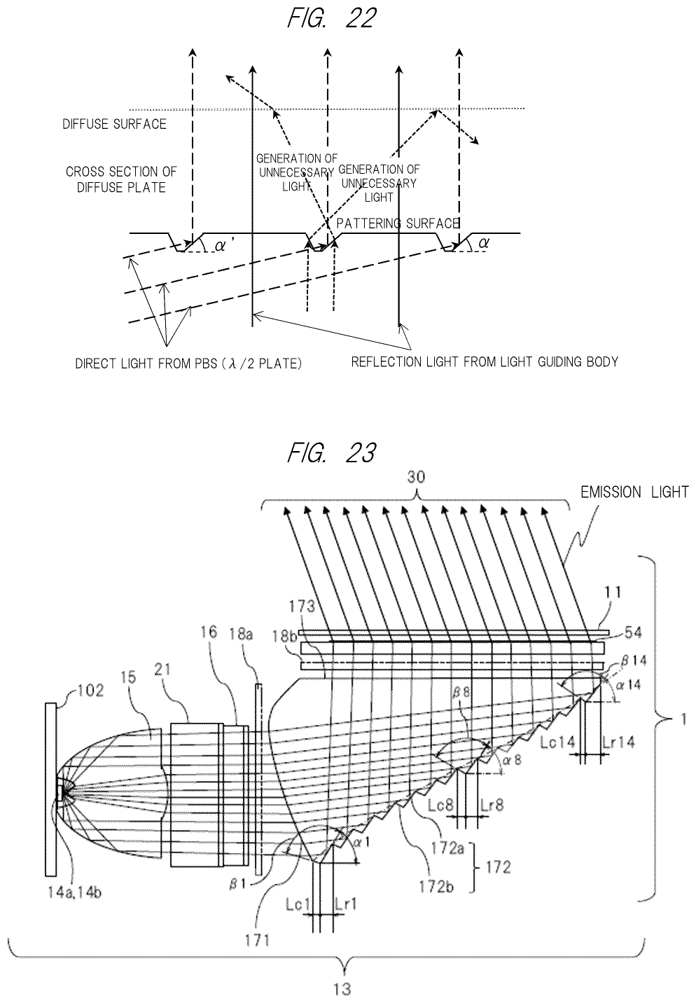

FIG. 22 is a cross-sectional view showing one example of a shape of the diffuse plate 206. As described above, the diffuse light emitted from the LED is converted to the substantially collimated light by the reflector 300 or the collimator 18, and is converted to have the specific polarized wave by the polarization converter element 21, and then, is reflected by the light guiding body. Then, the light flux having been reflected by the light guiding body is transmitted through a plane portion of a light entering surface of the diffuse plate 206, and enters the liquid crystal display panel 11 (see two solid-line arrows indicating “the reflection light emitted from the light guiding body” in FIG. 22).

The diffuse light flux of the light having been emitted from the polarization converter element 21 is totally reflected by a tilt surface of a protrusion having an oblique surface formed on the light entering surface of the diffuse plate 206, and enters the liquid crystal display panel 11. For the total reflection of the light having been emitted from the polarization converter element 21 by the tilt surface of the protrusion of the diffuse plate 206, an angle of the tilt surface of the protrusion is changed in accordance with the distance from the polarization converter element 21. When an angle of the tilt surface of the protrusion far from the polarization converter element 21 or far from the LED is set to “α” while an angle of the tilt surface of the protrusion close to the polarization converter element 21 or close to the LED is set to “α′”, α is smaller than α′ (α<α′). By such setting, the light flux having been converted in terms of the light polarization can be effectively used.

### Technique of Controlling Diffuse Property of Video Display Apparatus

As a method of adjusting the diffuse distribution of the video light emitted from the liquid crystal display panel 11, optimization of a shape of a lenticular lens arranged between the light source apparatus 13 and the liquid crystal display panel 11 or on the surface of the liquid crystal display panel 11 is exemplified. In other words, by the optimization of the shape of the lenticular lens, the light emission property of the video light (also referred to as “video light flux” below) emitted in one direction from the liquid crystal display panel 11 can be adjusted.

A micro lens array in a matrix form may be alternatively or additionally arranged on the surface of the liquid crystal display panel 11 (or between the light source apparatus 13 and the liquid crystal display panel 11) to adjust an aspect of the arrangement. In other words, by the adjustment of the arrangement of the micro lens array, the light emission property of the video light flux emitted from the video display apparatus 1 in the X-axis direction and the Y-axis direction can be adjusted, and, as a result, a video display apparatus having the desirable diffuse property can be provided.

As another configuration example, combination of two lenticular lenses may be arranged, or a sheet in which the micro lens array in the matrix form is arranged for adjusting the diffuse property may be arranged, at a position at which the video light emitted from the video display apparatus 1 passes. By such an optical system configuration, a luminance (relative luminance) of the video light in the X-axis direction and the Y-axis direction can be adjusted in accordance with the reflection angle of the video light (the reflection angle provided when the reflection in the vertical direction is set to a criterion (0 degree)).

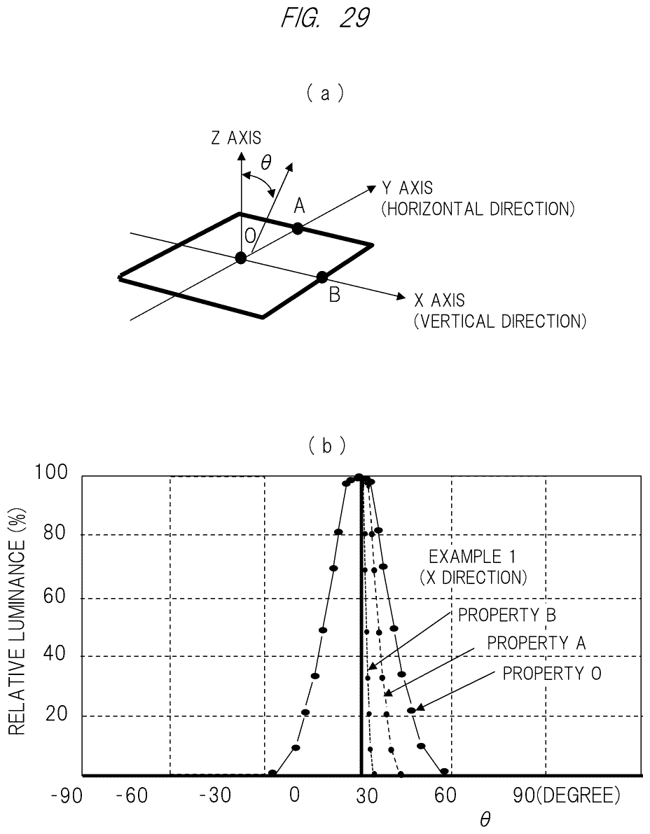

Because of use of such a lenticular lens, the present example can provide the excellent optical property as shown with the graph (plot curve) of “the Example 1 (Y-axis direction)” and “the Example 2 (Y-axis direction)” in FIG. 29 (B) that is clearly different from the graph (plot curve) of the related-art property. Specifically, in the plot curve of “the Example 1 (Y-axis direction)” and “the Example 2 (Y-axis direction)”, the luminance property in the vertical direction is made sharp, and the balance of the directionality of the up and down directions (the positive and negative directions in the Y-axis direction) is changed, and, as a result, the luminance (relative luminance) of the light due to the reflection and the diffuse can be increased.

Therefore, the present example can provide the video light having the narrow diffuse angle (high rectilinear propagation) and only the specific polarized wave component as similar to the video light emitted from the surface-emitting light laser video source, can suppress the ghost image generated in the retroreflector in the case of the use of the video display apparatus of the related art, and can adjust the light so that the air floating video generated by the retroreflection efficiently reaches the eyes of the viewer.

By the light source apparatus, the diffuse property (referred to as “related-art property” in the drawings) of the light emitted from the general liquid crystal display panel as shown in FIGS. 30 (A) and (B) can be provided with the directionality having the significantly narrow angle in both the

X-axis direction and the Y-axis direction. Since the present example can provide such directionality having the narrow angle, the video display apparatus emitting the nearly collimated video light flux in the specific direction and emitting the light with the specific polarized wave can be achieved.

FIG. 30 shows one example of the property of the lenticular lens applied to the present example. In this example, the property in the X-axis direction (vertical direction) with respect to the Z-axis direction is particularly exemplified, and a property “O” indicates a luminance property having a peak of the light emission direction at an angle that shifts upward by nearly 30 degrees from the vertical direction (0 degree) and being symmetric in the up-and-down direction. Plot curves of a property “A” and a property “B” shown in the graph of FIG. 30 indicate property examples in which the luminance (relative luminance) is increased by collection of the upper video light of the peak luminance at nearly 30 degrees. Therefore, in these properties A and B, as seen from the comparison with the plot curve of the property O, the luminance (relative luminance) of the light is rapidly decreased in a region of an angle (θ>30°) where the tilt (angle θ) from the Z-axis direction toward the X direction exceeds 30 degrees.

In other words, according to the optical system including the lenticular lens, when the video light flux emitted from the image display apparatus 1 is caused to enter the retroreflector, the light emission angle and the viewing angle of the video light having the equalized narrow angle by the light source apparatus 13 can be adjusted, and the degree of freedom of the layout of the retroreflection sheet can be significantly improved. As a result, the degree of freedom regarding the image forming position of the air floating video formed at the desirable position after being reflected by or transmitted through the window glass can be significantly improved. As a result, the light serving as the light having the narrow diffuse angle (high rectilinear propagation) and having only the specific polarized wave component can efficiently reach the eyes of the viewer outside or inside the room. Therefore, even if the intensity (luminance) of the video light emitted from the video display apparatus 1 is decreased, the viewer can correctly recognize the video light and obtain the information. In other words, the information display system having the low power consumption because of the small output of the video display apparatus 1 can be achieved.

### Exemplary Configuration of Retroreflector

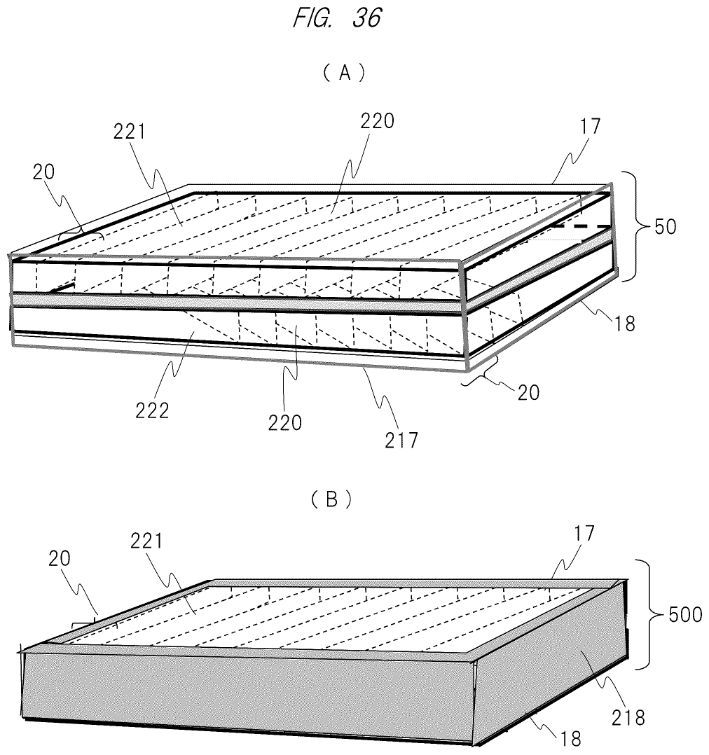

FIG. 36 illustrates other configuration of the second retroreflector 5 according to the present invention. In a retroreflector 50 of FIG. 36(A) or a retroreflector 500 of FIG. 36(B) that are other examples of the second retroreflector 5 of FIG. 2, the first light control panel 221 or the second light control panel 222 is formed by vertically arranging the optical members 20 with many belt-shaped reflection portions and a predetermined width or distance on one side of the plate 17 or 18. The first light control panel 221 and the second light control panel 222 are fixed to the transparent plates 17 and 18 provided substantially vertical to the reflection portions of the optical members 20, respectively. Here, the reflection portions of the optical members 20 configuring the first light control panel 221 and the second light control panel 222 cross (in the embodiment, are orthogonal to) each other in plan view, and will be referred to as plane light reflection portions 220 below. The first light control panel 221 and the second light control panel 222 according to the present embodiment are adhered by an adhesive. Further, the first light control panel 221 and the second light control panel 222 are adhered and fixed to the transparent plates 17 and 18, respectively. Each of the transparent plates 17 and 18 is referred to as transparent plate in the present specification. However, each of them may not only be transparent, but may be not transparent. Note that the light control panel may be referred to as light control member.

The first light control panel 221 will be described below. In the first light control panel 221, a plurality of optical members 20 are arranged in parallel, and one surface of each optical member 20 is provided with a plane light reflection portion 220. Further, the plane light reflection portion 220 is generally formed by a depositing or sputtering technique to deposit a reflection film on the surface of the optical member 20, and an adhesive that is easy to use is applicable to an adhesive for fixing them. The first light control panel 221 and the transparent plate 17 are irradiated with ultraviolet rays from the side of the transparent plate 17 to be adhesively fixed by an ultraviolet-cure type acrylic adhesive. Similarly, in the second light control panel 222, the optical members 20 are arranged in parallel, and the optical members 20 are adhered to each other. Further, the second light control panel 222 is also adhesively fixed to the transparent plate 18. It has been revealed by experiments that the viewer recognizes, as an abnormal phenomenon, the double reflection surfaces due to an interface between the adhesive and the air in the entering of the external light into the retroreflector, and determines the phenomenon as member defect, the entering being caused by reflection on the interface other than the normal reflection surface, the interface being caused by infiltration of liquid such as moisture through an end surface of the retroreflector 50 manufactured by the above-described method to separate the adhered surface.

In order to solve the above problem, the present inventors have found that the infiltration of the moisture or the like can be prevented by applying a resin-based adhesive 217 originally used as an adhesive to a joint portion of the end surface of the retroreflector 50 as illustrated in FIG. 36(A) to cover the joint portion exposed from the end surface, and that a silicon-based adhesive also has an effect of preventing the infiltration of the liquid such as moisture because of being capable of expanding or shrinking even if the transparent plates 17 and 18 are made of resin and change in outer dimension due to temperature variation or expansion by absorbed moisture, and capable of absorbing the changed shape of the transparent plates 17 and 18 to stably cover the joint portion. Further, the resin-based adhesive 217 may be transparent or non-transparent. In FIG. 36(A), the transparent resin-based adhesive 217 is used, and the transparent resin-based adhesive 217 according to the present embodiment is, for example, an acrylic-modified silicon resin-based adhesive such as Super XG No777 by Cemedine Co., Ltd.

Further, in addition to the above-described end surface processing, the infiltration of the moisture or the like is also effectively prevented by adhering a moisture-proof tape 218 to the end surface of the retroreflector 500 as illustrated in FIG. 36(B). Further, more excellent waterproof effect can be achieved by a double prevention structure that are the covering of the end surface with the adhesive 217 and the adhesion of the moisture-proof tape 218 against the infiltration of the liquid such as moisture. Further, the moisture-proof tape 218 may be transparent or non-transparent. For example, Strong Waterproof Repair Tape BBT-50 (Scotch) is used. As the air floating video information display system using the resultant retroreflector, a system with high resistance to environmental changes can be achieved.

### Method of Manufacturing Retroreflector

As described above, in each of the light control members 221 and 222 of the retroreflector 50 or the retroreflector 500, the optical members 20 are arranged in parallel, and the optical members 20 cross each other. Further, the light control members 221 and 222 are fixed to the transparent plates 17 and 18 by the ultraviolet-cure type adhesive, respectively.

For the transparent plate 17 and the transparent plate 18, note that a plastic without an ultraviolet absorber (absorbing light of 400 nm or less) for transmitting the ultraviolet rays is typically used. On the other hand, the ultraviolet-ray exposure experiment made by the present inventors has caused a problem that a plastic base material reacted with the ultraviolet rays and turned to yellow. As countermeasures against the problem, a plastic with the ultraviolet absorber is used for the transparent plate 17 arranged on the external-light entering side, and the light control member 221 is irradiated with the ultraviolet rays from the opposite side of the transparent plate 17 and is adhered by the ultraviolet-cure type adhesive. On the other hand, the plastic without the ultraviolet absorber is used for the transparent plate 18, and therefore, the light control member 222 is irradiated with the ultraviolet rays from the side of the transparent plate 18 to be adhered, and is adhesively fixed by the ultraviolet-cure type adhesive.

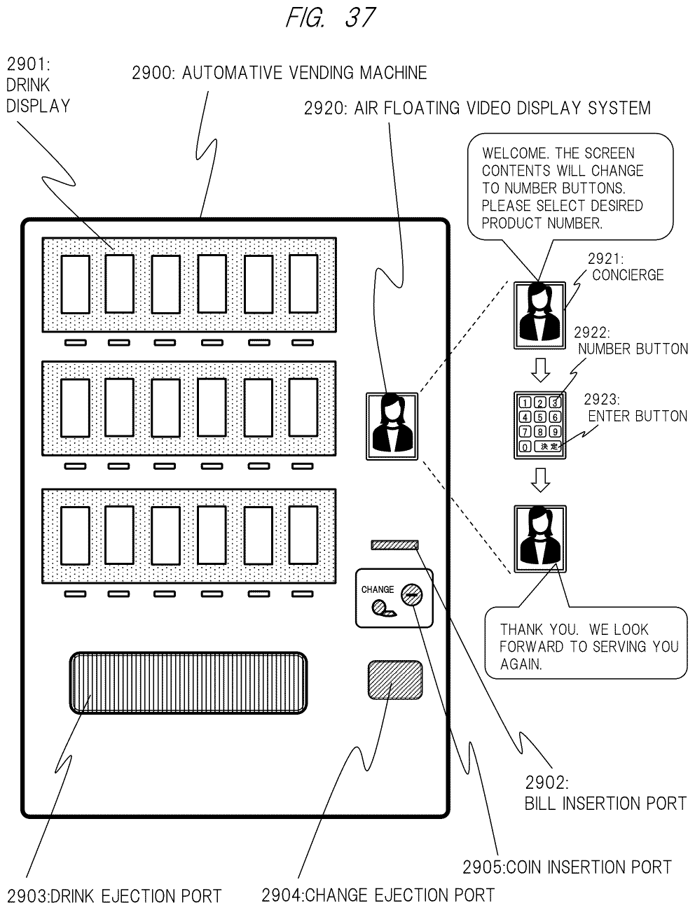

As a result, as illustrated in FIG. 37, an air floating video information display system 2920 is also applicable to an automatic vending machine 2900 for commercial products used in outdoors including a drink display 2901, a bill insertion port 2902, a drink ejection port 2903, a change ejection port 2904, a coin insertion port 2905 and the like.

In the example of FIG. 37, for example, a concierge 2921 is displayed on the air floating video information display system 2920, and the system emits a voice sound (audio) saying that The screen changes to the number buttons. Please “Welcome. select the desired product number.”. Then, a number button 2922 and an enter button 2923 are displayed. When the product number is pressed on the number button 2922, and then, the enter button 2923 is pressed, the product of the product number is ejected from the drink ejection port 2903. The concierge 2921 is displayed again, and the system emits a voice sound (audio) saying that, for example, “Thank you. We look forward to serving you again” for the end.

### First Technique of Improving Cooling Efficiency of Light Source Apparatus

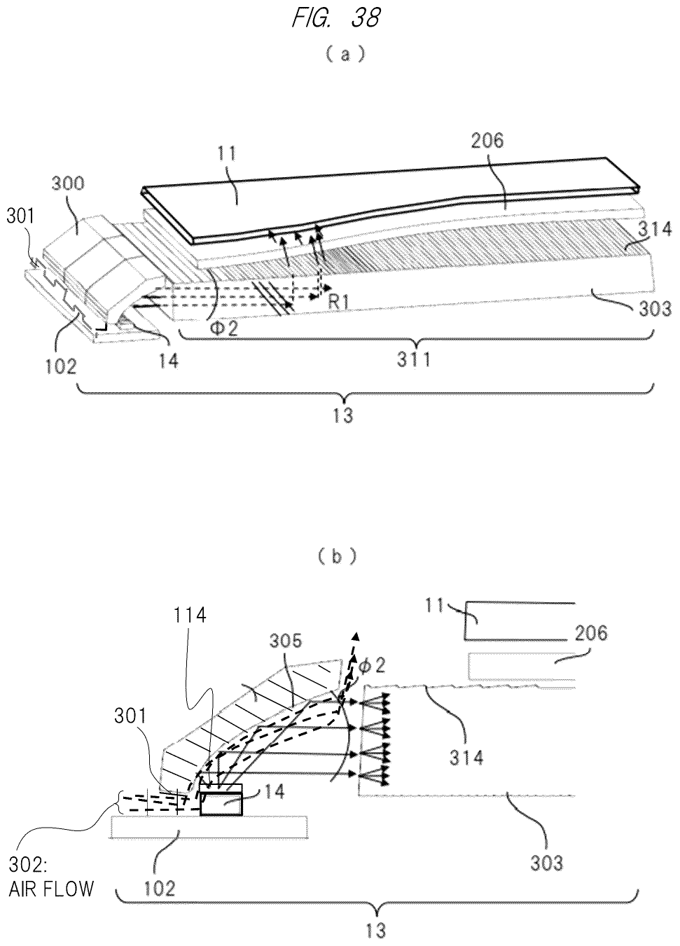

For the embodiments according to the present invention, a structure provided in the reflector 300 for improving cooling efficiency of the light source apparatus will be described with reference to FIG. 38. FIGS. 38(a) and 38(b) are diagrams in which the liquid crystal display panel 11 and the diffuse plate 206 are partially omitted for explaining the reflector 300.

FIG. 38 illustrates a state in which the substrate 102 is provided with the LED 14 configuring the light source. The LED 14 and the substrate 102 are attached at predetermined positions to correspond to the reflector 300. Further, when the LED 14 is provided with a phosphor 114, the phosphor 114 may be expressed as a light emitter portion of the light source.

As illustrated in FIG. 38(a), the LEDs 14 are arranged on one line in a direction parallel to a side (short side in this example) of the liquid crystal display panel 11, being close to a region where the reflector 300 is arranged. The reflector is made of a plastic material, a glass material, or a metallic material. The reflector 300 includes an opening 301 formed therein corresponding to a position of the LED 14 or the phosphor 114 that is the light emitter portion of the light source on a side being in contact with the substrate 102. The opening 301 is provided between the substrate 102 on which the LED 14 is arranged and the reflector 300, and is used to flow air inside from outside. By the inflow of the air from the outside through the opening 301, the LED 14 can be cooled. Further, a plurality of openings 301 may be provided as illustrated in FIG. 38, or one opening may be provided although not illustrated. If the plurality of openings are provided, the openings are formed to correspond to the positions of the LEDs 14 or the phosphors 114, respectively, such that one opening may be provided to correspond to one LED 14 or one phosphor 114 or such that the plurality of openings may be provided to correspond to one LED 14 or one phosphor 114. If the plastic reflector 300 is used, a structure of direct inflow of the air from some parts of the reflection surfaces 305 of the reflector 300 is applied, and thus, low-temperature air (cooling air) flows inside from a space not facing the reflection surfaces 305 of the reflector 300 to cause air convection along the reflection surfaces 305 of the reflector 300.

By the cooling of the reflector 300 as described above, a margin for heat distortion temperature is secured. Further, the increase in temperature can be similarly suppressed even if the glass or metallic reflector 300 is used. Also, since the cooling air also contacts the end surface of the LED 14, the temperature of the LED also lowers to suppress the decrease in the light emission efficiency of the LED. The light guiding body has been described with reference to the transmission-type light guiding body 311 in FIG. 38. However, the reflection-type light guiding body 306 as illustrated in FIG. 20 may be used.

At input power of 0.16 W, a white LED employed by the present inventors provides light output of 30 (lm). However, the light conversion efficiency of the white LED is provided as a product of a light conversion efficiency of a blue LED and an excitation efficiency of the phosphor, and a total efficiency is about 30% while the remaining energy is converted into heat. A junction temperature of the LED is increased by the heat generated at this time, and the increase exceeding 110 degrees remarkably decreases the light emission efficiency.

FIG. 38(b) illustrates a structure of the light source apparatus configured to efficiently cool the LEDs and to decrease the temperature of the plastic reflector. In FIG. 38(b), a cross-sectional shape of the reflector 300 is illustrated with an oblique line. Further, the air inflow 302 through the opening 301 is illustrated with a dotted-line arrow. As described above, the inner surface of the reflector 300 has the reflection surface (referred to as “paraboloid surface” below) 305 having the shape resulted from cut of the paraboloid surface at the meridional plane. In the reflector 300, the diffuse light emitted from the LED 14 is converted to the substantially collimated light by being reflected by the reflection surface 305 (paraboloid surface), and the converted light is caused to enter the end surface of the light guiding body 311. The opening 301 is formed in a part of the reflector 300 to generate the structure of the direct air inflow from some of the reflection surfaces 305 of the reflector 300, and cools the end surfaces of the reflector 300 and the LED 14.

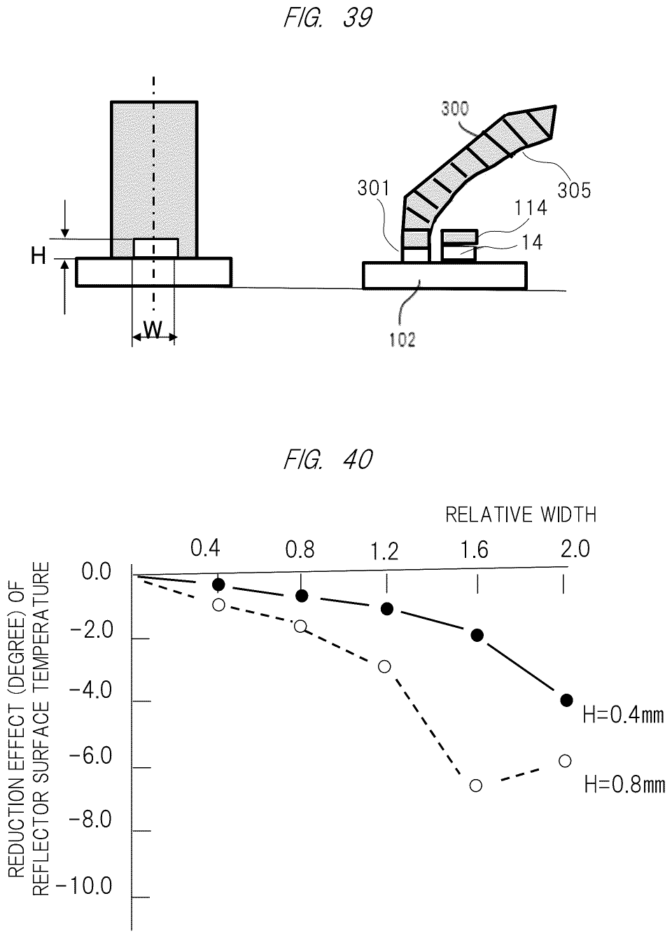

The reflection surface of the reflector 300 has the shape that is asymmetric across the optical axis of the light emitted from the LED 14, and is of the paraboloid surface, and the LED is arranged at the focal point of this paraboloid surface, and therefore, is away by a predetermined distance from the reflection surface. The LED 14 is away by the predetermined distance from the reflection surface 305 of the reflector 300, and therefore, and is cooled together with the end surface of the LED 14 by the cooling air inflow through the opening 301. As illustrated in FIGS. 38(b) and 39, note that an upper end of the opening 301 in the optical axis direction of the light source is configured to be lower than a lower end of the phosphor 114.

That is, in the optical axis direction of the light source, the light emitter portion of the light source is upper than the upper end of the opening 301. The lower end of the opening 301 is on a side where the substrate 102 is arranged.

Next, explanation will be made with reference to examples. As illustrated in FIG. 39, by actual measurements using the LED 14 having a one side length of 1 mm and including the phosphor 114 having a thickness of 0.5 mm, the present inventors have found an opening area of the opening 301 and a surface temperature decrease effect of the reflection surface 305 of the reflector 300. As a result, as illustrated in FIG. 40, a surface temperature of the reflection surface 305 of the reflector 300 is actually measured under two conditions of a height H of the opening 301 to be 0.4 mm and 0.8 mm while a width W of the opening 301 is used as a parameter. The temperature decrease effect under the height H of 0.4 mm is increased when a relative area is 1.0 or more. The temperature decrease effect under the height H of 0.8 mm is increased when the relative area is 1.2 or more, but is decreased when the relative area is 2.0. As described above, it has been found there is a region providing the favorable decrease effect because of change of the cooling efficiency under use of the dimension of the opening as the parameter relative to the side area of 1.0 mm×0.4 mm (relative area of 0.5) of the LED. Thus, the width of the opening may be desirably 1.2 times or more and 1.6 times or less of the width of the side surface of the light source.

Further, the employed LED 14 is the white surface-emitting light source in which the phosphor is excited by a blue LED with a height of 0.5 mm and a width W of 1.0 mm, and is arranged at the focal point of the paraboloidal surface of the reflector 300 to be away by the predetermined distance from the reflection surface 305 of the reflector 300. Thus, when the junction temperature of the LED is decreased from about 120 degrees to 100 degrees by the inflow of the low-temperature air from the outside of the reflector in order to cool the side surface of the LED 14, the light emission efficiency is improved by 10% or more. In the present embodiment, note that the surface-type light source is exemplified as the light source for the explanation. However, as the light source, a point-type light source using the LED or other light source may be employed.

As described above, the effect in the case of the plastic reflector 300 having the opening 301 has been explained. However, even if the base material of the reflector 300 is glass or metal, the junction temperature is decreased by the cooling of the temperature of the reflection surface 305 or the side surface of the light source, and, as a result, the unique effect for the present invention that is the increase in the light emission efficiency of the light source is provided.

In the foregoing, various embodiments or examples (that are specific examples) to which the present invention is applied have been concretely described. Meanwhile, the present invention is not limited to the foregoing embodiments (specific examples), and includes various modification examples. In the above-described embodiments, for example, the entire system has been explained in detail for easily understanding the present invention, and the above-described embodiments do not always include all components explained above. Also, a part of the structure of one embodiment can be replaced with the structure of another embodiment, and besides, the structure of another embodiment can be added to the structure of one embodiment. Further, another structure can be added to/eliminated from/replaced with a part of the structure of each embodiment.

### Fifth Exemplary Configuration of Air Floating Video Information Display System

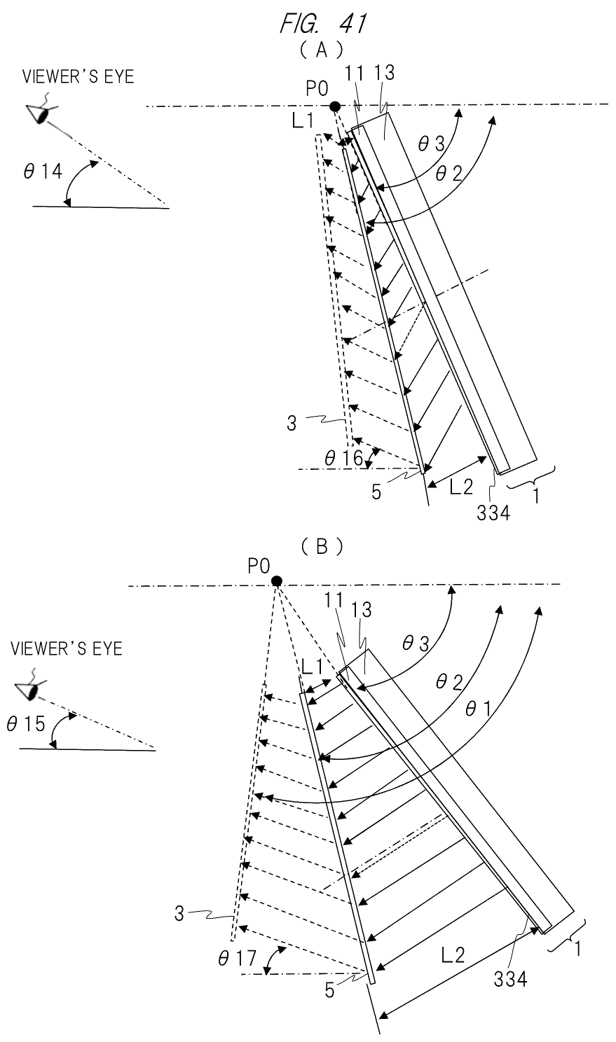

This exemplary configuration will be described by use of the second retroreflector 5 described above. FIG. 41 is a diagram illustrating a configuration of main components of other exemplary retroreflection optical system for achieving the air floating video display system. The air video display system of FIG. 41 is suitable for the viewer who is viewing the air floating video from obliquely above. The video display apparatus 1 includes the liquid crystal display panel 11 as a video display device and the light source apparatus 13 configured to generate light of specific polarization with narrow-angle diffuse property. In the present embodiment, the liquid crystal display panel 11 is configured of a liquid crystal display panel with a screen size of about 5 inches to 80 inches or more.

In the air floating video display system illustrated in FIGS. 41(A) and 41(B), the video display apparatus 1 and the retroreflector 5 are fixed by a structure (not illustrated), and the fixed structure is rotated by a hinge (not illustrated) provided at a rotation center PO. Rotation of the structure enables an orientation of the air floating video display system to be changed such that the viewer can view the air floating video with high luminance and high contrast in the viewing direction. By change of an attachment angle of the structure to the housing, the image forming position of the air floating video is changed. Further, the rotation center of the structure relative to the housing is upper than the liquid crystal display panel 11, the light source apparatus 13 and the retroreflector 5. An angle between the video display apparatus 1 and the retroreflector 5 about the rotation center P0 is a difference between θ3 and θ2 illustrated in FIG. 41(A), and the difference between θ3 and θ2 may be constant or variable. That is, the angle between the video display apparatus 1 and the retroreflector 5 about the rotation center PO is referred to as an included angle between the video display apparatus 1 and the retroreflector 5. Further, an angle between the retroreflector 5 and the air floating video 3 about the rotation center PO is a difference between θ1 and θ2 illustrated in FIG. 41(B).

The air floating video display system may have a structure in which the video display apparatus 1 and the retroreflector 5 are movable at a predetermined angle between the video display apparatus 1 and the retroreflector 5 about the rotation center P0. Further, the air floating video display system may have a structure in which either one of the video display apparatus 1 and the retroreflector 5 is moved about the rotation center P0 to adjust the angle between the video display apparatus 1 and the retroreflector 5. By such a structure, a degree of freedom in mounting the air floating video display system onto an apparatus targeted for the mounting is remarkably improved. As illustrated in FIG. 41(B), if the difference between θ3 and θ2 increases, the distance between the retroreflector 5 and the air floating video 3 also increases, and therefore, the air floating video 3 can be displayed as if more floating in air. That is, when the angle between the video display apparatus 1 and the retroreflector 5 is adjusted to widen the forming position, a sufficient floating degree can be achieved. Angles θ14 and θ15 illustrated in FIG. 41 indicate angles at which the viewer looks at the air floating video display system, and the angle θ14 is larger than the angle θ15.

On the other hand, for example, the tilt angle θ2 of the retroreflector 5 is set to 85 degrees or less in order to prevent the external light having entered the second retroreflector 5 from reflecting and returning toward the viewer's eyes. Additionally, the tilt angle θ2 is more preferably set to 80 degrees or less in order to increase a margin of the reflection light for the external light. At this time, the rotation center PO of the housing is preferably arranged on an extension line of the plane of the second retroreflector 5 to be arranged lower than the viewing position (eyes' position) of the viewer. As a result, the resultant air floating video is also formed at a position which the viewer looks down to, and the video light emitted from the retroreflector 5 is emitted toward the viewer.

Further, as illustrated in FIG. 41, the liquid crystal display panel 11 and the retroreflector 5 are tilted in order to cause the video light emitted from the liquid crystal display panel 11 to obliquely enter the retroreflector 5. As a result, the space formed by the retroreflector 5 and the video display apparatus 1 including the liquid crystal display panel 11 can be narrowed or reduced, and therefore, the optical system capable of achieving a small-size air floating video display system can be provided. Further, the video light ray is obliquely emitted by the video light control sheet 334 to nearly have the incidence angle of 45 degrees maximizing the reflection efficiency of the retroreflector 5.

The video light control sheet 334 is close to the video display surface of the liquid crystal display panel 11 of the video display apparatus 1, and the video light is refracted in a desired direction, and, as a result, the incidence angle of the video light entering the retroreflector 5 can be increased. That is, the video light control sheet 334 is arranged between the retroreflector 5 and the liquid crystal display panel 11 to adjust the emission direction of the video light flux emitted from the liquid crystal display panel 11.

A case of use of the linear Fresnel sheet 105 as illustrated in FIG. 10 as the video light control sheet 334 as similar to the fourth embodiment will be described. The light emitted from the light source apparatus 13 with a narrow divergence angle described later is caused to enter the liquid crystal display panel 11 to generate a video light flux of narrow divergence angle, the video light flux is caused to enter the retroreflector 5 from the linear Fresnel sheet 105 to form the air floating video 3. Further, a circular Fresnel lens sheet may be used as the video light control sheet 334. The diffuse angle and the diffuse direction of the video light flux diffused from the air floating video are adjusted by a refractive index and a Fresnel angle of the base material of the circular Fresnel sheet or linear Fresnel sheet configuring the video light control sheet. The air floating video 3 is formed to be symmetrical to the display surface of the video display apparatus 1 across the retroreflector 5 serving as the symmetrical surface. In this embodiment, the retroreflector 5 and the video display apparatus 1 are tilted. Therefore, even if the viewer looks at the retroreflector 5 of the air floating video display apparatus, the video displayed on the liquid crystal display panel 11 does not overlap with the air floating video, and does not reduce the image quality of the air floating video.

In order to prevent the video light from overlapping with the air floating video, the video-light emitting surface of the liquid crystal display panel 11 is provided with the video light control sheet 334 as similar to the fourth embodiment. For the video light control sheet, for example, a viewing-angle control film (VCF) manufactured by Shin-Etsu Polymer Co., Ltd., is suitable. A structure of the VCF has a sandwich structure in which transparent silicon and black silicon are alternately arranged while the light entering/emitting surface is provided with a synthetic resin. Therefore, the same effect as that of the external-light control film of the present embodiment can be expected. In this case, in the viewing-angle control film (VFC), the transparent silicon and the black silicon both extending in a predetermined direction are alternately arranged. Therefore, as illustrated in FIG. 13, the direction of the extension of the transparent silicon and the black silicon of the video light control sheet 334 is tilted (by θ10 in FIG. 13) from the vertical direction to the arrangement of the pixels of the liquid crystal display panel 11 to reduce the moire formed at the pitch of the pixel and the external-light control film.

Also in the fifth embodiment, for example, the retroreflector 5 is arranged in parallel with the bottom surface of the housing. As a result, in addition to the effects due to the above-described configuration, the ghost images formed in the air floating video 3 can be eliminated in order to prevent the reduction of the image quality of the air floating video 3 formed by the incidence of the external light on the retroreflector 5 and the entering into the housing. Further, in order to form the high-quality air floating video 3, as similar to the second, third, and fourth embodiments, the emission side of the liquid crystal display panel 11 may be provided with the video light control sheet 334 as illustrated in FIGS. 14(A) and 14(B) to control the diffuse property of the unnecessary direction. On the other hand, the video emission surface of the retroreflector 5 may be also provided with the video light control sheet 334 to eliminate the ghost images formed on both sides of the normal image of the air floating video 3 due to the unnecessary light. When the above-described structure is arranged inside the housing, the entering of the external light into the retroreflector 5 is prevented to prevent the formation of the ghost images.

The light source apparatus described above is also applicable to not only the air floating video display apparatus but also an information display apparatus such as HUD, tablet, and digital signage.

In the techniques according to the present embodiments, the air floating video is displayed in a state where the high-resolution and high-luminance video information is aerially floated, and, as a result, for example, the user can perform operations without concern about contact infection in illness. When the techniques according to the present embodiments are applied to the system that is used by a large number of unspecified users, a contactless user interface having the less risk of the contact infection in illness and being available without the concern can be provided. The present invention providing such a technique contributes to “the third goal: Good Health and Well-being (for all people)” of the sustainable development goals (SDGs) advocated by the United Nations.

And, since only the normal reflection light is efficiently reflected with respect to the retroreflector by the techniques according to the present embodiments of making the divergence angle of the emitted video light small and making the equalized specific polarized wave, the light use efficiency is high, and the bright and clear air floating video can be provided. The techniques according to the present embodiments can provide a contactless user interface being excellent in availability and capable of significantly reducing the power consumption. The invention providing such a technique contributes to “the ninth goal: Industry, Innovation and Infrastructure” and “the eleventh goal: Sustainable Cities and Communities” of the sustainable development goals (SDGs) advocated by the United Nations.

Further, the techniques according to the present embodiments can form the air floating video made of the video light having the high directionality (rectilinear propagation). In the techniques according to the present embodiments, even in case of display of the video that requires the high security in an ATM at bank, a ticketing machine at station and so forth or display of the video having high confidentiality that needs to be confidential to a person who faces the user, the display of the video light having the high directionality can provide a contactless user interface having the less risk of the peek at the air floating video by the person different from the user. The present invention provides the above-described techniques, and therefore, contributes to “the eleventh goal: Sustainable Cities and Communities” of the sustainable development goals (SDGs) advocated by the United Nations.

### EXPLANATION OF REFERENCE CHARACTERS

1 . . . video display apparatus, 2 . . . first retroreflector, 5 . . . second retroreflector, 3 . . . air image (air floating image), 100 . . . transmittable plate, 13 . . . light source apparatus, 54 . . . light-direction converter panel, 105 . . . linear Fresnel sheet, 101 . . . absorption-type polarization sheet (absorption-type polarization plate), 200 . . . plane display, 201 . . . housing, 203 . . . sensing system, 217 . . . resin-based adhesive, 218 . . . moisture-proof tape, 226 . . . sensing area, 102 . . . substrate, 11 and 335 . . . liquid crystal display panel, 206 . . . diffuse plate, 21 . . . polarization converter element, 300 . . . reflector, 301 . . . opening, 302 . . . air flow, 305 . . . reflection surface, 213 . . . 2/2 plate, 306 . . . reflection-type light guiding body, 307 . . . reflection surface, 308 and 310 . . . sub-reflector, 204 . . . air floating video, 334 . . . video light control sheet, 336 . . . light transmitting portion, 337 . . . light absorbing portion, 81 . . . optical element, 501 . . . polarization converter element, 503 . . . unit, 507 . . . light shielding wall, 401 and 402 . . . light shielding plate, 320 . . . base material, 511 . . . housing, 512 . . . support arm, 513 . . . hinge, 514 . . . back cover, 515 . . . housing cover, 516 . . . housing base, 517 and 518 . . . tilted linear Fresnel sheet, 519 . . . eccentric Fresnel sheet, 2900 . . . automatic vending machine, 2901 . . . drink display, 2902 . . . bill insertion port, 2903 . . . drink ejection port, 2904 . . . change ejection port, 2905 . . . coin insertion port, 2920 . . . air floating video information display system, 2921 . . . concierge, 2922 . . . number button, 2923 . . . enter button

1. An air floating video display apparatus comprising:
a display panel configured to display a video;
a light source apparatus for the display panel;
a retroreflector configured to reflect video light emitted from the display panel and to cause the reflected light to aerially display an air floating video of a real image; and
a video light control sheet configured to convert an optical path of the video light,
wherein the video light control sheet is arranged between the retroreflector and the display panel to adjust an emission direction and a divergence angle of a video light flux emitted from the display panel.

2. The air floating video display apparatus according to claim 1, wherein the video light control sheet is a linear Fresnel lens sheet.

3. The air floating video display apparatus according to claim 1, wherein the video light control sheet is a circular Fresnel lens sheet.

4. The air floating video display apparatus according to claim 1,
wherein a diffuse angle and a diffuse direction of a video light flux diffused from the air floating video is adjusted by a refractive index and a Fresnel angle of a base material of a circular Fresnel sheet or a linear Fresnel sheet configuring the video light control sheet.

5.-7. (canceled)

8. An air floating video display apparatus comprising:
a display panel configured to display a video;
a light source apparatus configured to emit light to the display panel; and
a retroreflector configured to reflect video light emitted from the display panel and to cause the reflected light to aerially display an air floating video of a real image,
wherein the retroreflector includes two light control members, and
the two light control members are adhered by an adhesive.

9. The air floating video display apparatus according to claim 8,
wherein, the retroreflector is configured such that an adhesive is applied to an end surface of a joint portion where the two light control members are joined to each other.

10. The air floating video display apparatus according to claim 8,
wherein the retroreflector is configured such that a moisture-proof tape is attached to an end surface of a joint portion where the two light control members are joined to each other.

11. The air floating video display apparatus according to claim 8,
wherein the retroreflector is configured such that an adhesive is applied to an end surface of a joint portion where the two light control members are joined to each other, and besides, a moisture-proof tape is attached thereto.

12. The air floating video display apparatus according to claim 9,
wherein a silicon-based adhesive is applied as the adhesive to the end surface where the two light control members are joined to each other.

13. The air floating video display apparatus according to claim 8,
wherein the light control member includes an optical member, and
a reflection film is formed on one surface of the optical member by a deposition or sputtering technique.

14. The air floating video display apparatus according to claim 1,
wherein the light control member is adhesively fixed to a plate by an ultraviolet-cure type acrylic adhesive when being irradiated with ultraviolet ray from a side of the plate.

15. The air floating video display apparatus according to claim 14,
wherein the number of the plates is two, and
either one of the two plates is made of plastic containing an ultraviolet absorber.

16. A retroreflector configured to reflect light emitted from a light source apparatus, comprising:
two light control members,
wherein the two light control members are adhered by an adhesive, and
the light control member is configured such that optical members are arranged in parallel, and is fixed to a plate provided substantially vertically to a reflection portion of the optical member.

17. The retroreflector according to claim 16,
wherein the retroreflector is configured such that an adhesive is applied to an end surface of a joint portion where the two light control members are joined to each other.

18. The retroreflector according to claim 16,
wherein the retroreflector is configured such that a moisture-proof tape is attached to an end surface of a joint portion where the two light control members are joined to each other.

19. The retroreflector according to claim 16,
wherein the retroreflector is configured such that an adhesive is applied to an end surface of a joint portion where the two light control members are joined to each other, and besides, a moisture-proof tape is attached thereto.

20. The retroreflector according to claim 17,
wherein a silicon-based adhesive is applied as the adhesive to the end surface where the two light control members are joined to each other.

21. The retroreflector according to claim 16,
wherein the light control member includes an optical member, and
a reflection film is formed on one surface of the optical member by a deposition or sputtering technique.

22. The retroreflector according to claim 16,
wherein the light control member is adhesively fixed to a plate by an ultraviolet-cure type acrylic adhesive when being irradiated with ultraviolet ray from a side of the plate.

23. The retroreflector according to claim 16,
wherein the number of the plates is two, and
either one of the two plates is made of plastic containing an ultraviolet absorber.

24.-27. (canceled)

28. A light source apparatus comprising:
a light source;
a reflector configured to reflect light emitted from the light source; and
a light guiding body configured to guide light emitted from the reflector toward the video display apparatus,
wherein an opening is formed in a part of the reflector closer to the light source.

29. The light source apparatus according to claim 28,
wherein a width of the opening is 1.2 times or more and 1.6 times or less of a width of a side surface of the light source.

30. The light source according to claim 28,
wherein a light emitter portion of the light source is upper than an upper end of the opening in an optical axis direction of the light source.

31. The light source according to claim 28,
wherein the opening is formed between the reflector and a substrate on which the light source is arranged, and enables air to flow from outside.

32. An air floating video display apparatus comprising:
a video display apparatus including a display panel configured to display a video and a light source apparatus configured to supply light to the display panel; and
a retroreflector configured to reflect video light emitted from the display panel and to cause the reflected light to aerially display an air floating video of a real image,
wherein an image forming position of the air floating video is changed by adjusting an included angle between the video display apparatus and the retroreflector that are fixed by a structure.

33. The air floating video display apparatus according to claim 32, comprising:
a housing including the structure,
wherein a rotation center of the structure relative to the housing is upper than the display panel, the light source apparatus and the retroreflector.

34. The air floating video display apparatus according to claim 32,
wherein a display position of the air floating video is located at a desired position by rotation of the structure about a rotation center of the structure.

35. The air floating video display apparatus according to claim 32, comprising:
a video light control sheet on a video display surface of the display panel,
wherein the video light control sheet is arranged between the retroreflector and the display panel to adjust an emission direction of a video light flux emitted from the display panel.

36. The air floating video display apparatus according to claim 35,
wherein the video light control sheet is a linear Fresnel lens sheet.

37. The air floating video display apparatus according to claim 35,
wherein the video light control sheet is a circular Fresnel lens sheet.

37. The air floating video display apparatus according to claim 35,
wherein a diffuse angle and a diffuse direction of a video light flux diffused from the air floating video is adjusted by a refractive index and a Fresnel angle of a base material of a circular Fresnel sheet or a linear Fresnel sheet configuring the video light control sheet.

39.-40. (canceled)
